(19) United States
(12) Patent Application Publication
(10) Pub. No.: US 2026/0300046 A1
(43) Pub. Date: Oct. 1, 2026

(54) GRAPH-BASED MODELS WITH TRIGGER NODES

(71) Applicant: Infosys Limited, Bangalore (IN)

(72) Inventor: Steven SCHILDERS, Columbus, IN (US)

(73) Assignees: Infosys Limited, Bangalore, KA (IN); InvertIT Inc., Columbus, IN (US)

(21) Appl. No.: 19/093,162

(22) Filed: Mar. 27, 2025

(51) Int. Cl. G06F 9/54

(52) U.S. Cl. CPC G06F 9/542

(57) ABSTRACT

An overlay system is provided that includes a storage element and processing circuitry coupled thereto. The storage element stores an executable graph-based model that includes a plurality of active nodes and a plurality of trigger nodes. Each trigger node is associated with at least one active node of the plurality of active nodes. The processing circuitry detects, using a first trigger node of the plurality of trigger nodes, an event associated with a first active node of the plurality of active nodes. The processing circuitry determines, using the first trigger node, a set of operations to be executed in response to the first event. The processing circuitry further executes, based on the first active node and the first trigger node, the set of operations in response to the first event.

### FIELD OF THE DISCLOSURE

Various embodiments of the present disclosure relate generally to graph-based models. More specifically, various embodiments of the present disclosure relate to implementation of trigger nodes in the graph-based models.

### BACKGROUND

Graph-based models have become a cornerstone of modern technology, offering an intuitive and efficient way to represent complex systems in various domains such as marketing, research, social networks, and recommendation engines. These graph-based models represent entities as vertices and their interconnections as edges, enabling seamless visualization and analysis of relationships and dependencies. In addition to these foundational components, overlay systems often incorporate overlay nodes, which include processing logic. When executed on the associated nodes, these overlay nodes perform specific operations related to the nodes they are linked with.

However, execution of overlay nodes in a conventional graph-based model is contingent on presence of a stimulus. In absence of the stimulus, processing logic embedded within the overlay nodes may remain dormant. This dependency on the stimulus may introduce delays in operation, which may directly impact performance of the conventional graph-based model. The reliance on stimulus may result in increased wait times for execution of operations, thereby reducing an overall throughput of a system implementing the conventional graph-based model. Moreover, performance of the conventional graph-based model may decline in environments where the stimulus is unpredictable or poorly controlled. In use cases requiring high-speed processing and real-time responsiveness, this limitation may significantly hamper the efficiency and scalability of the conventional graph-based model.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating implementation of trigger nodes in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes and a plurality of trigger nodes. Each trigger node is associated with at least one active node of the plurality of active nodes. The processing circuitry is configured to identify a first active node of the plurality of active nodes. Further, the processing circuitry is further configured to determine a first trigger node, of the plurality of trigger nodes, associated with the first active node. The processing circuitry is further configured to detect, using the first trigger node, a first event associated with the first active node. Further, the processing circuitry is further configured to determine, using the first trigger node, a set of operations to be executed in response to the first event. The processing circuitry is further configured to execute, based on the first active node and the first trigger node, the set of operations in response to the first event.

In some embodiments, the first event is detected based on a set of criteria associated with the first trigger node.

In some embodiments, the first event is detected further based on the set of criteria being complied with in association with the first active node.

In some embodiments, the executable graph-based model further includes a plurality of overlay nodes. The processing circuitry is further configured to determine one or more overlay nodes, of the plurality of overlay nodes, associated with the first trigger node. The set of operations is executed further based on the one or more overlay nodes associated with the first trigger node.

In some embodiments, the first trigger node includes an overlay manager configured to manage the association of the first trigger node with the one or more overlay nodes.

In some embodiments, the executable graph-based model further includes a plurality of overlay nodes. The processing circuitry is further configured to determine at least two overlay nodes, of the plurality of overlay nodes, associated with the first trigger node. The at least two overlay nodes are associated with the first trigger node in a series of cascading overlay nodes. The set of operations is executed further based on the at least two overlay nodes associated with the first trigger node.

In some embodiments, the first trigger node includes an overlay manager configured to manage at least one of a group consisting of (i) the association of the first trigger node with the at least two overlay nodes, or (ii) a sequence of applications of the at least two overlay nodes for the execution of the set of operations.

In some embodiments, the processing circuitry is further configured to determine a second trigger node, of the plurality of trigger nodes associated with the first trigger node. The set of operations is executed further based on the second trigger node.

In some embodiments, the processing circuitry is further configured to determine a third trigger node, of the plurality of trigger nodes, associated with the first active node. The set of operations is executed further based on the third trigger node.

In some embodiments, the processing circuitry is further configured to determine at least a fourth trigger node, of the plurality of trigger nodes, inherited by the first trigger node. The set of operations is executed further based on at least the fourth trigger node.

In some embodiments, the executable graph-based model further includes a plurality of overlay nodes. The processing circuitry is further configured to determine one or more overlay nodes, of the plurality of overlay nodes, associated with the fourth trigger node. The set of operations is executed further based on the one or more overlay nodes associated with the fourth trigger node inherited by the first trigger node.

In some embodiments, the processing circuitry is further configured to determine a second active node, of the plurality of active nodes, associated with the first trigger node. The set of operations is executed further based on the second active node.

In some embodiments, the executable graph-based model further includes a plurality of group nodes with each group node including two or more active nodes of the plurality of active nodes. The processing circuitry is further configured to identify a first group node, of the plurality of group nodes, which includes the first active node. The first active node is associated with the first trigger node by way of the first group node. The set of operations is executed further based on the first group node.

In some embodiments, the executable graph-based model further includes a plurality of overlay nodes. The processing circuitry is further configured to determine one or more overlay nodes, of the plurality of overlay nodes, associated with the first group node. The set of operations is executed further based on the one or more overlay nodes associated with the first group node.

In some embodiments, the processing circuitry is further configured to determine a second group node, of the plurality of group nodes, associated with the first group node. The set of operations is executed further based on the second group node.

In some embodiments, the first active node is a generic node, and the first trigger node is a generic trigger node.

In some embodiments, the first active node is a run-time node including (i) a node template that is a predefined node structure and (ii) a node instance that is an implementation of the node template. Further, the first trigger node is a run-time trigger node having (i) a trigger node template that is a predefined trigger node structure and (ii) a trigger node instance that is an implementation of the trigger node template.

In some embodiments, the executable graph-based model further includes a plurality of overlay nodes. The processing circuitry is further configured to determine two or more overlay nodes, of the plurality of overlay nodes, associated with the first trigger node. The set of operations is executed further based on the two or more overlay nodes. The trigger node template of the first trigger node defines a sequence of applications of the two or more overlay nodes for the execution of the set of operations.

In some embodiments, based on the first trigger node being the run-time trigger node, each of the two or more overlay nodes is a run-time overlay node having (i) an overlay node template that is a predefined overlay node structure and (ii) an overlay node instance that is an implementation of the overlay node template.

In some embodiments, an active node of the plurality of active nodes is one of a group consisting of: an edge node, a vertex node, a role node, or an overlay node.

In some embodiments, a trigger node of the plurality of trigger nodes has a trigger node-type, the trigger node-type is a combination of an edge node-type and an overlay node-type.

In some embodiments, a method is provided. The method comprising, identifying, by processing circuitry of an overlay system, a first active node of a plurality of active nodes of an executable graph-based model. The method further comprising, determining, by the processing circuitry, a first trigger node, of a plurality of trigger nodes of the executable graph-based model, associated with the first active node. The executable graph-based model is stored in a storage element of the overlay system. The executable graph-based model includes a plurality of active nodes and a plurality of trigger nodes. Each trigger node of the plurality of trigger nodes is associated with at least one active node of the plurality of active nodes. The method further comprising, detecting, by the processing circuitry using the first trigger node, a first event associated with the first active node. The method further comprising, determining, by the processing circuitry using the first trigger node, a set of operations to be executed in response to the first event. The method further comprising, executing, by the processing circuitry, based on the first active node and the first trigger node, the set of operations in response to the first event.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of a generic trigger node within the executable graph-based model, consistent with disclosed embodiments of the present disclosure;

FIG. 4B is a block diagram that illustrates a standard structure of a run-time trigger node within the executable graph-based model, consistent with disclosed embodiments of the present disclosure;

FIG. 5A is a block diagram that illustrates an executable generic trigger node within the executable graph-based model, consistent with disclosed embodiments of the present disclosure;

FIG. 5B is a block diagram that illustrates an executable run-time trigger node within the executable graph-based model, consistent with disclosed embodiments of the present disclosure;

FIG. 6 is a block diagram that illustrates a composition of the executable generic trigger node that enables persistent storage of data and processing logic associated therewith, consistent with disclosed embodiments of the present disclosure;

FIGS. 7A and 7B, collectively, illustrate graphs that depict implementation of a plurality of trigger nodes in the executable graph-based model, consistent with disclosed embodiments of the present disclosure;

FIG. 8 illustrates a graph that depicts a user data management system implemented based on the overlay system, consistent with disclosed embodiments of the present disclosure;

FIG. 9 shows an example computing system for carrying out methods of the present disclosure, consistent with disclosed embodiments of the present disclosure; and

FIG. 10 illustrates a flowchart of a method for implementation of a trigger node in the executable graph-based model, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

With technological advancements, graph-based models have become a vital tool for representing complex systems and their interconnections. Widely used in fields such as marketing, research, social networks, recommendation systems, and logistics, the graph-based models efficiently represent entities as vertices and their relationships as edges. For instance, in marketing, individual vertices might represent customers, products, and transactions, while in research or social networking, vertices could correspond to documents, keywords, or users. This structure facilitates effective visualization and querying of patterns, dependencies, and interactions.

Beyond standard nodes (for example, vertices and edges), the graph-based models may incorporate overlay nodes that contain embedded processing logic. This processing logic is designed to perform specific operations on the nodes with which the overlay nodes are associated, enabling advanced computational capabilities within the graph-based models.

However, current implementations of the graph-based models may rely heavily on stimulus to invoke the execution of overlay nodes. Without such invocations, the embedded processing logic may remain dormant and may further create unnecessary delays in initiating operations. This dependency may not only increase the wait time for execution but may also limit the ability of the graph-based models to achieve high throughput, as operations may not proceed autonomously. Furthermore, this stimulus-driven approach may introduce inefficiencies in scenarios requiring continuous, real-time processing, such as in dynamic network environments or large-scale systems with high-frequency updates.

The present disclosure is directed to facilitation of trigger nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates implementation of trigger nodes in the executable graph-based model. The executable graph-based model may include a plurality of active nodes and a plurality of trigger nodes such that each trigger node is associated with one or more active nodes. A trigger node may monitor the executable graph-based model to determine whether a set of criteria associated therewith are being matched by a set of conditions within the overlay system. Based on occurrence of the set of conditions that match the set of criteria, the trigger node may detect an event. The event may have to be followed with execution of a set of operations based on an active node associated with the trigger node. Therefore, based on the detection of the event, the trigger node may determine the set of operations and subsequently, may execute the set of operations based on the associated active node. The set of operations may be executed further based on one or more overlay nodes or additional trigger nodes directly or indirectly associated with the active node or the trigger node.

Thus, execution of the set of operations based on the detection of the event significantly reduces dependency of the overlay system on stimulus for execution of operations. Such an execution of the set of operations incorporates automation with the overlay system. The automation allows the overlay system to execute the set of operations without waiting for a stimulus. Consequently, latency associated with the set of operations may be significantly reduced and a throughput of the overlay system may be significantly increased. This allows for significant reduction of idle time associated with various resources (for example, processing circuitry, storage element, or the like) of the overlay system. The implementation of the trigger nodes in the executable graph-based model allows for an optimal use of resources associated with the overlay system. Therefore, the implementation of the trigger nodes allows for significant improvement in an overall performance of the overlay system.

### Figure Description

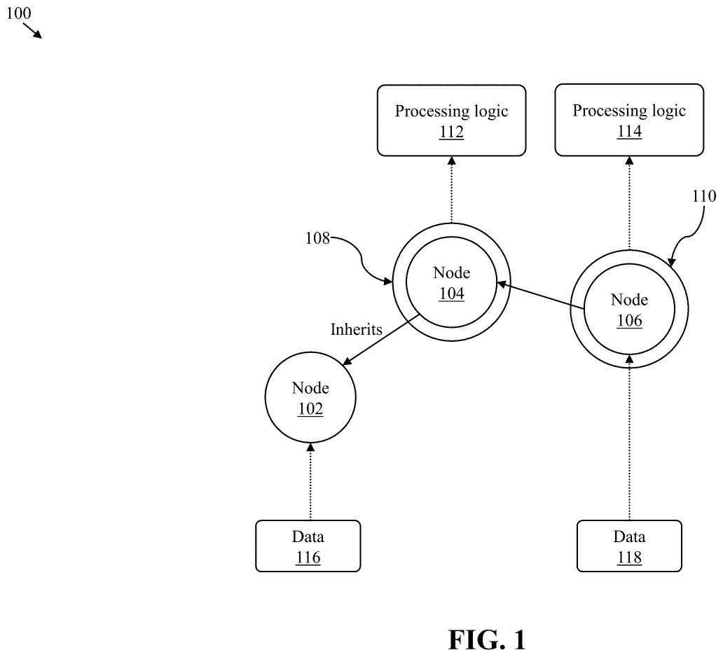

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106 which can be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102. Nodes of the executable graph-based model 100 may be active nodes.

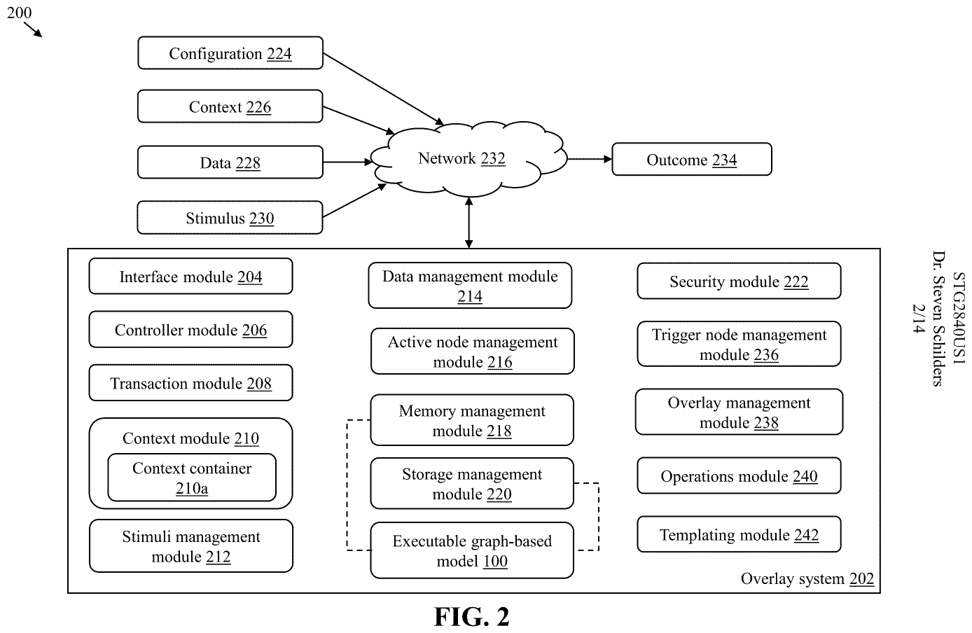

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 includes a trigger node management module 236, an overlay management module 238, an operations module 240, and a templating module 242. In some embodiments, all the modules of the overlay system 202 except for the executable graph-based model 100 may collectively form processing circuitry that facilitates operations associated with a plurality of active nodes of the executable graph-based model 100. The plurality of active nodes may include generic nodes and run-time nodes.

A generic node may refer to a node, in the executable graph-based model 100, with an edge node-type, a role node-type, an overlay node-type, or a vertex node-type. A first generic node with the vertex node-type is coupled to a second generic node with the vertex node-type by way of a third generic node with the edge node-type indicative of roles of the first and second generic nodes. A run-time node may include a node template and a node instance. The node template may be a predefined node structure and the node instance may be an implementation of the predefined node structure. The run-time node may have an edge node-type, a role node-type, an overlay node-type, or a vertex node-type. A first run-time node with the vertex node-type is coupled to a second run-time node with the vertex node-type by way of a third run-time node with the edge node-type indicative of roles of the first and second run-time nodes.

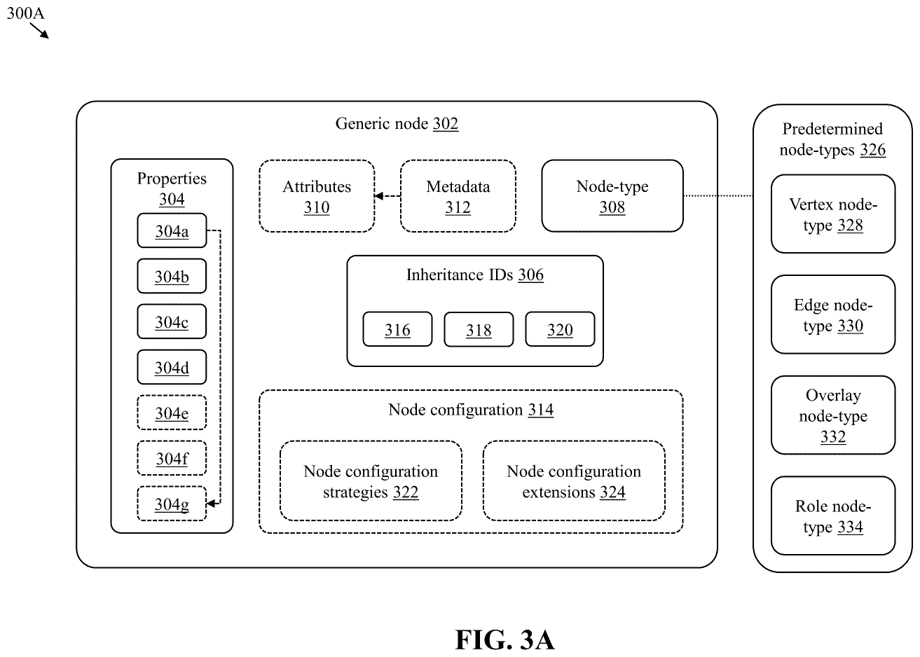

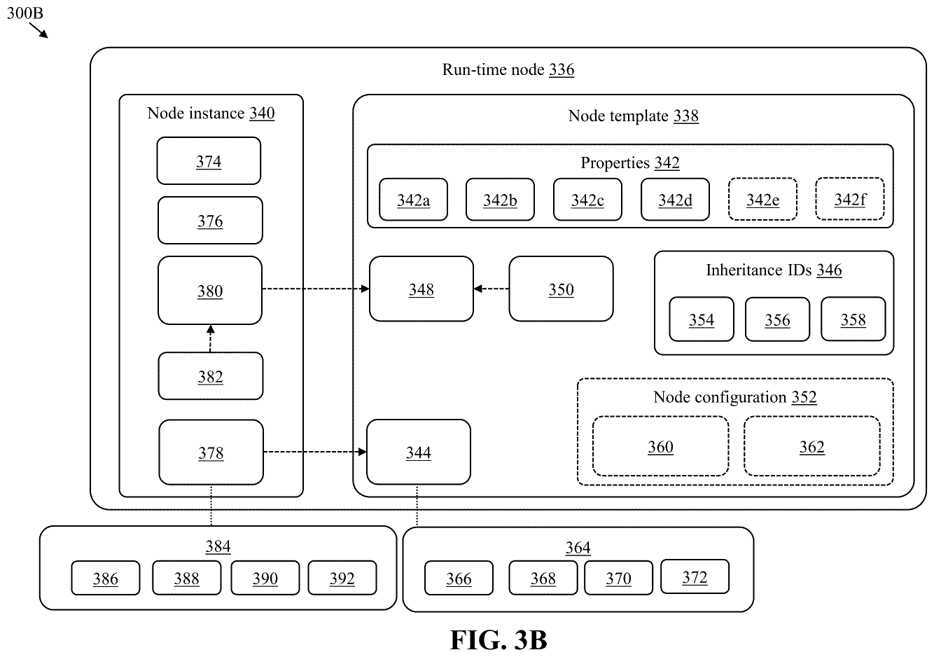

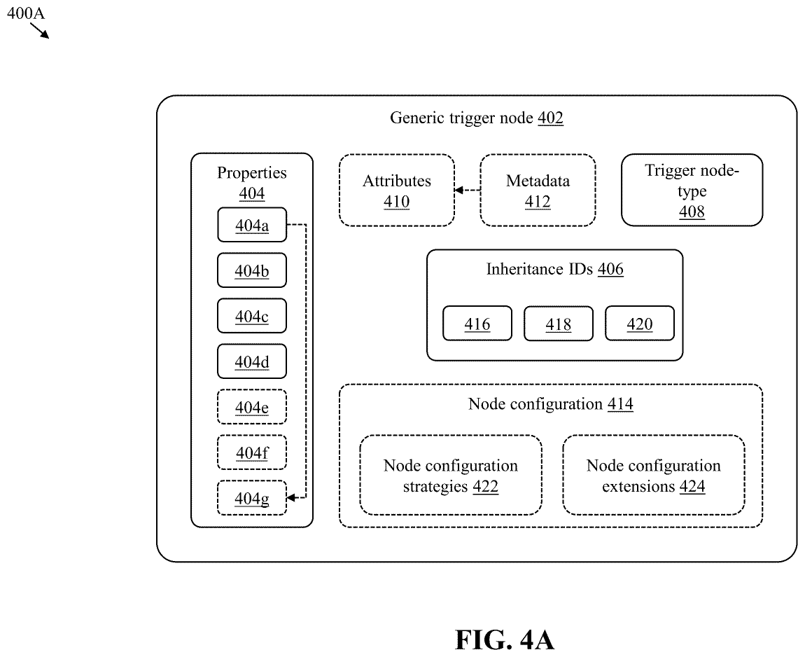

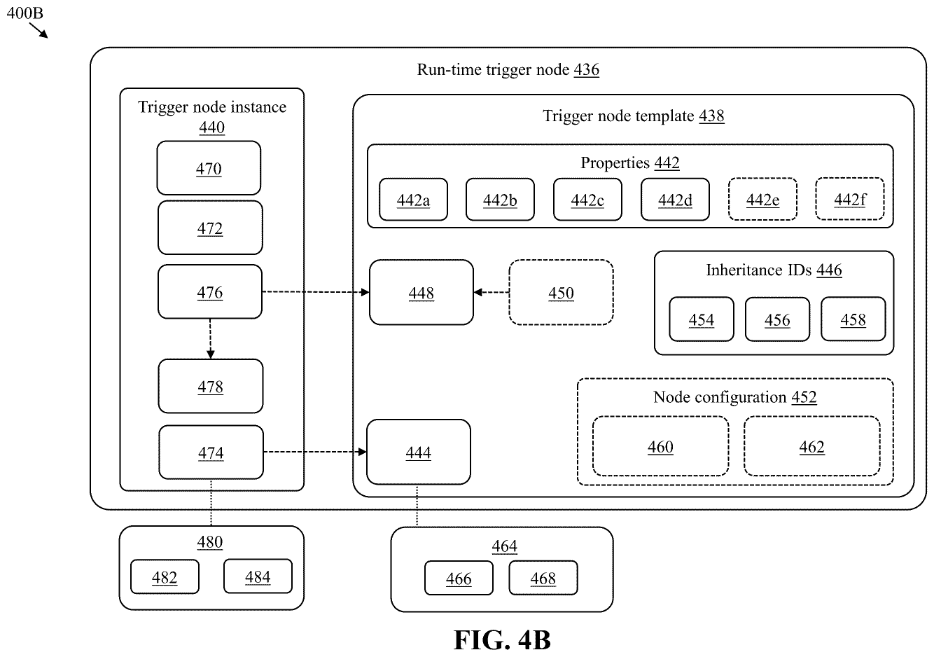

A standard node structure of the generic node and the run-time node (as described later in conjunction with FIGS. 3A and 3B, respectively) may be modified to form a generic trigger node (depicted in FIG. 4A) and a run-time trigger node (depicted in FIG. 4B), respectively, in the executable graph-based model 100. The generic trigger node and the run-time trigger node are collectively referred to as a trigger node. A trigger node is a node that may exhibit the capabilities of an overlay node and an edge node. Further, the trigger node may have a set of criteria associated therewith. The trigger node may be associated with at least one active node of the plurality of active nodes. In an instance, when the set of criteria of the trigger node may be complied/met by a set of conditions of the overlay system 202, processing logic associated with the trigger node may be executed based on the at least one active node associated therewith. Notably, the set of criteria when complied with the set of conditions may have to be followed by a set of operations. Therefore, the trigger node may determine the set of operations and the processing logic of the trigger node may cause the execution of the set of operations based on the at least one active node associated with the trigger node.

The overlay system 202 may include suitable logic, circuitry, interfaces, and/or code, executable by the circuitry, that may be configured to facilitate one or more operations associated with the nodes in the executable graph-based model 100. One or more modules (for example, the controller module 206, the transaction module 208, or the like) of the overlay system 202 may be modified and customized to execute one or more operations associated with creation and management of the trigger nodes and execution of transactions associated with the trigger nodes.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the active nodes) in the overlay system 202. That is to say that, one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 240 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

The active node management module 216 may include suitable logic, circuitry, interfaces, and/or code, executable by the circuitry, configured to manage, design, and implement the plurality of active nodes in the overlay system 202. The active nodes may include the generic nodes and the run-time nodes. Further, each active node may have a vertex node-type, an edge node-type, a role node-type, or an overlay node-type (described in conjunction with FIGS. 3A and 3B). The active node management module 216 is further configured to facilitate operations associated with execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independently of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

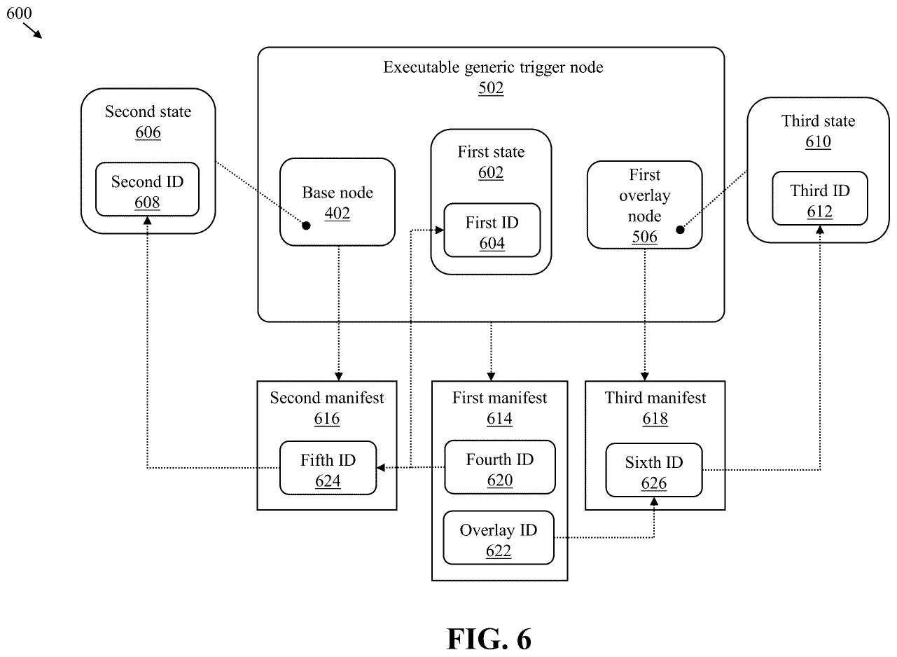

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of active nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of active nodes are described in detail in conjunction with FIG. 6.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 238 and the trigger node management module 236 for managing and executing security-based overlays and security-based operational functionalities associated with one or more trigger nodes.

The trigger node management module 236 may include suitable logic, circuitry, interfaces, and/or code, executable by the circuitry, configured to execute one or more operations associated with creation, management, storage, and implementation of the plurality of trigger nodes in the overlay system 202. The trigger node management module 236 may be further configured to manage association between a trigger node, of the plurality of trigger nodes, and an active node of the plurality of active nodes. The trigger node management module 236 may be further configured to manage association of a trigger node with another trigger node of the plurality of trigger nodes. The trigger nodes may include the generic trigger nodes and the run-time trigger nodes. Further, each trigger node may have a trigger node-type associated therewith. A trigger node-type may be a combination of an edge node-type and an overlay node-type. Thus, the trigger node may exhibit the capabilities of an edge node and an overlay node. The trigger node management module 236 is further configured to facilitate operations associated with execution of one or more transactions using the trigger nodes.

The overlay management module 238 may include suitable logic, circuitry, interfaces, and/or code, executable by the circuitry, configured to manage all overlays within the overlay system 202. The overlays may be generic overlays or run-time overlays. Generic overlays are associated with generic nodes and/or generic trigger nodes and extend functionality of the generic nodes and/or generic trigger nodes. A run-time overlay node is same as the generic overlay node. In addition, the run-time overlay node may include a node template and a node instance. Operations performed by the overlay management module 238 may include overlay storage management, overlay structure modeling, overlay logic creation and execution, and overlay loading and unloading (within the executable graph-based model 100). The overlay management module 238 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The operations module 240 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like) associated with the nodes (for example, the trigger nodes) of the executable graph-based model 100.

The templating module 242 may include suitable logic, circuitry, interfaces, and/or code, executable by the circuitry, configured to enable the overlay system 202 to implement a templated version of one or more nodes (for example, the trigger nodes, the overlay nodes, or the like) of the executable graph-based model 100. The templating module 242 may be configured to create one or more predefined templates in the executable graph-based model 100. The templating module 242 may be further configured to generate one or more node instances of the predefined node templates for the implementation of the templated version of the executable graph-based model 100. Notably, the templating module 242 ensures ontology integrity by enforcing structure and rules of a template when generating instances of the template at run-time. Ontology integrity refers to consistency, accuracy, and correctness of an ontology. Thus, the templating module 242 ensures that the consistency, accuracy, and correctness of the ontology of the executable graph-based model 100 are maintained while generating the instances of the template at run-time. The templating module 242 may be communicatively coupled (i.e., connected either directly or indirectly) to one or more nodes and/or one or more overlays within the executable graph-based model 100.

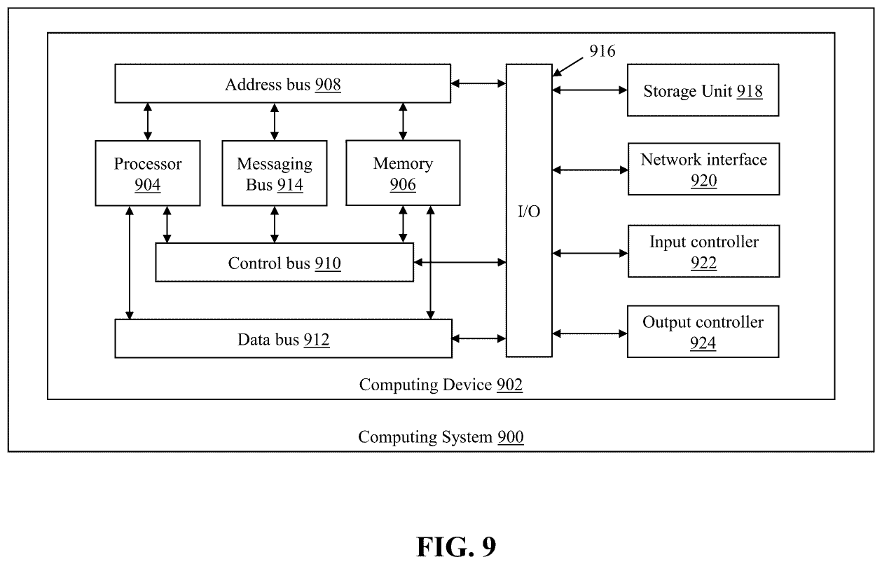

Beneficially, various features of the overlay system 202 support the processing circuitry and a computing system (shown in FIG. 9) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited. A node with an edge node-type may be referred to as an edge node, a node with a vertex node-type may be referred to as a vertex node, a node with an overlay node-type may be referred to as an overlay node or overlay, and a node with a role node-type may be referred to as a role node.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of the concrete node configuration strategies 322 is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake®, or the like) associated with the overlay system 202. All attribute configurations examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. In other words, the node instance 340 is an implementation of the node template 338. The run-time node 336 shown in FIG. 3B is a compositional structure that is generated and executed, at run-time as part of the executable graph-based model 100. In other words, the node template 338 is defined as ‘offline’ and the node instance 340 and the run-time node 336 are run-time structures that are dynamically generated during execution of the executable graph-based model 100.

The node template 338 comprises a predetermined node structure. Further, the node template 338 defines one or more rules that govern the generation of the node instance 340. The node instance 340 is an implementation of the predefined node structure of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 includes properties 342, a node-type template 344, inheritance IDs 346, and a set of attribute templates 348. The node template 338 may optionally include metadata 350 and a node configuration 352. The properties 342 of the node template 338 include a unique identifier (ID) 342a, a version ID 342b, a namespace 342c, a name 342d, and optionally include one or more icons 342e and a set of labels 342f. The inheritance IDs 346 comprise an abstract flag 354, a leaf flag 356, and a root flag 358. The node configuration 352 optionally comprises one or more node configuration strategies 360 and/or one or more node configuration extensions 362.

FIG. 3B further shows a plurality of predetermined node-type templates 364 of the node-type template 344. The plurality of predetermined node-type templates 364 includes a vertex node-type template 366, an edge node-type template 368, an overlay node-type template 370, and a role node-type template 372. Further, the node instance 340 includes a unique ID 374, a version ID 376, a node-type instance 378, and a set of attribute instances 380. The node instance 340 may optionally include metadata 382. FIG. 3B further shows a plurality of predetermined node-type instances 384 of the node-type instance 378. The plurality of predetermined node-type instances 384 include a vertex node-type instance 386, an edge node-type instance 388, an overlay node-type instance 390, and a role node-type instance 392.

The unique ID 342a is unique for each node template within the executable graph-based model 100. Similarly, the unique ID 374 is unique for each node instance within the executable graph-based model 100. The unique ID 342a and the unique ID 374 are used to register, manage, and reference the node template 338 and the node instance 340, respectively, within the overlay system 202. The version ID 342b of the node template 338 is incremented when the node template 338 undergoes a transactional change. Similarly, the version ID 376 of the node instance 340 is incremented when the node instance 340 undergoes a transactional change. The namespace 342c of the node template 338, along with the name 342d of the node template 338, is used to help organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which are used to provide a visual representation of the node template 338. The one or more icons 342e can include icons at different resolutions and display contexts such that the visualization of the node is adapted to different display contexts and settings. The node template 338 also optionally comprises the set of labels 342f which are used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model (such as the executable graph-based model 100). The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 346 of the node template 338 provide an indication of the inheritance-based information, which is applicable, or can be applicable, to the node template 338. The inheritance IDs 346 have a description that is similar to the inheritance IDs 306. The abstract flag 354 has a description that is similar to the abstract flag 316, the leaf flag 356 has a description that is similar to the leaf flag 318, and the root flag 358 has a description that is similar to the root flag 320.

In embodiments, when an active node may be a run-time node, all elements within the executable graph-based model 100 are defined as node templates or node instances. The functionality of the node template 338 and the node instance 340 are realized due to the use of the node-type template 344 and the node-type instance 378. The node-type template 344 of the node template 338 is used to extend the functionality of the node template 338 by defining the standard set of capabilities, including data and associated behavior.

The vertex node-type template 366 (also referred to as a data node-type) includes a template of common data structures and functionality related to the ‘things’ modeled in the graph (e.g., the data). The vertex node-type instance 386 includes the common data structures and functionality related to the ‘things’ modeled in the graph based on the vertex node-type template 366. The edge node-type template 368 includes a template of common data structures and functionality related to joining two or more nodes. A node instance having the edge node-type instance 388 may connect two or more nodes and thus the edge node-type instance 388 constructs associations and connections between nodes (for example objects or ‘things’) within the executable graph-based model 100. The edge node-type instance 388 is not restricted to the number of nodes that can be associated or connected by a node having the edge node-type instance 388. The data structures and functionality of the edge node-type instance 388 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 370 is used to extend the functionality of a node template (e.g., the node template 338) to incorporate processing logic. Similarly, the overlay node-type instance 390 is used to extend the functionality of a node instance (e.g., the node instance 340) to incorporate processing logic.

The set of attribute templates 348 corresponds to the data defined by the node template 338. For example, the set of attribute templates 348 may define the names and value types (e.g., integer, string, float, etc.) of one or more attributes but not the values of these attributes. The values of the set of attribute templates 348 may be defined by the set of attribute instances 380 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 380 is associated with an attribute template of the set of attribute templates 348. The node template 338 may define one or more default values for the set of attribute templates 348. The default values correspond to the values that the attributes take if no value is assigned. The metadata 350 (e.g., data stored as a name, a value type, and a value triplet) is associated with either the node template 338 or one or more of the set of attribute templates 348 of the node template 338. Similarly, the node instance 340 also optionally comprises the metadata 350 (e.g., data stored as a name, a value type, and a value triplet) which is associated with either the node instance 340 or one or more of the set of attribute instances 380.

The node configuration 352 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake^{®}, or the like) associated with the overlay system 202.

It will be apparent to a person skilled in the art that each node of the executable graph-based model 100 has a standard structure that is similar to the generic node 302 of FIG. 3A or the run-time node 336 of FIG. 3B.

FIG. 4A is a block diagram 400A that illustrates a standard structure of a generic trigger node 402 within the executable graph-based model 100, consistent with disclosed embodiments of the present disclosure. Referring to FIG. 4A, the generic trigger node 402 corresponds to the core structure of the executable graph-based model 100 and forms the foundational building block for various data and processing logic within the executable graph-based model 100. The generic trigger node 402 includes properties 404, inheritance IDs 406, a trigger node-type 408, attributes 410, metadata 412, and a node configuration 414.

The properties 404 include a unique ID 404a, a version ID 404b, a namespace 404c, a name 404d, one or more icons 404e, one or more labels 404f, and one or more alternative IDs 404g. The properties 404 of the generic trigger node 402 have a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g have descriptions similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the generic trigger node 402 include an abstract flag 416, a leaf flag 418, and a root flag 420. The inheritance IDs 406 of the generic trigger node 402 has a description similar to the description of the inheritance IDs 306 of the generic node 302. In other words, the abstract flag 416, the leaf flag 418, and the root flag 420 have descriptions similar to the descriptions of the abstract flag 316, the leaf flag 318, and the root flag 320, respectively, of the generic node 302.

The generic trigger node 402 may have the trigger node-type 408. The trigger node-type 408 may be combination of the edge node-type and the overlay node-type. The edge node-type and the overlay node-type may be similar to the edge node-type 330 and the overlay node-type 332, respectively. In other words, the edge node-type has a description similar to the description of edge node-type 330 shown in FIG. 3A and the overlay node-type template has a description similar to the description of the overlay node-type 332 as shown in FIG. 3A.

The attributes 410 of the generic trigger node 402 have a description similar to the description of the attributes 310 of the generic node 302. In addition, the metadata 412 has a description similar to the description of the metadata 312 of the generic node 302.

The node configuration 414 of the generic trigger node 402 includes node configuration strategies 422 and node configuration extensions 424. The node configuration 414 is same as the node configuration 314 of the generic node 302. In other words, the node configuration strategies 422 and the node configuration extensions 424 of the generic trigger node 402 are the same as the node configuration strategies 322 and the node configuration extensions 324, respectively, of the generic node 302.

FIG. 4B is a block diagram 400B that illustrates a standard structure of a run-time trigger node 436 within the executable graph-based model 100, consistent with disclosed embodiments of the present disclosure. Referring to FIG. 4B, the run-time trigger node 436 corresponds to the core structure of the executable graph-based model 100 and forms the foundational building block for all data and processing logic within the executable graph-based model 100.

The run-time trigger node 436 is shown to include a trigger node template 438 and a trigger node instance 440. The trigger node instance 440 is generated according to the trigger node template 438. The trigger node template 438 forms a data structure for the trigger node instance 440. Notably, the trigger node template 438 corresponds to a predefined trigger node structure. The trigger node instance 440 may be an implementation of the trigger node template 438. The trigger node instance 440 may include a reference (for example, a point, a storage location, or the like) associated with the trigger node template 438.

The run-time trigger node 436 shown in FIG. 4B is a compositional structure that is generated and executed, at run-time as part of the executable graph-based model 100. In other words, the trigger node template 438 is defined as ‘offline’ and the trigger node instance 440 and the run-time trigger node 436 may be run-time structures that may be dynamically generated during execution of the executable graph-based model 100.

The trigger node template 438 has a description similar to the description of the node template 338 described in conjunction with FIG. 3B, whereas the trigger node instance 440 has a description similar to the description of the node instance 340 described in conjunction with FIG. 3B.

The trigger node template 438 may include properties 442, a trigger node-type template 444, inheritance IDs 446, and a set of attribute templates 448. The trigger node template 438 may optionally include metadata 450 and node configuration 452. The properties 442 of the trigger node template 438 include a unique identifier (ID) 442a, a version ID 442b, a namespace 442c, a name 442d, and optionally include one or more icons 442e and a set of labels 442f. The inheritance IDs 446 comprise an abstract flag 454, a leaf flag 456, and a root flag 458. The node configuration 452 optionally comprises one or more node configuration strategies 460 and/or one or more node configuration extensions 462. FIG. 4B further shows a predetermined trigger node-type template 464. The predetermined trigger node-type template 464 may be a combination of an edge node-type template 466 and an overlay node-type template 468.

The trigger node instance 440 may include a unique ID 470, a version ID 472, trigger node-type instance 474, and a set of attribute instances 476. The trigger node instance 440 may optionally include metadata 478. FIG. 4B further shows a predetermined trigger node-type instance 480. The predetermined trigger node-type instance 480 may be a combination of an edge node-type instance 482 and an overlay node-type instance 484.

The properties 442 of the trigger node template 438 may have a description that is similar to the description of the properties 342 described in conjunction with FIG. 3B. In other words, the unique ID 442a, the version ID 442b, the namespace 442c, the name 442d, the icons 442e, and the set of labels 442f may have descriptions that may be similar to descriptions of the unique ID 342a, the version ID 342b, the namespace 342c, the name 342d, the icons 342e, and the set of labels 342f, respectively, shown in FIG. 3B.

The inheritance IDs 446 of the trigger node template 438 has a description that is similar to the inheritance IDs 346 of the node template 338. In other words, the abstract flag 454, the leaf flag 456, and the root flag 458 may have descriptions that may be similar to the descriptions of the abstract flag 354, the leaf flag 356, and the root flag 358, respectively, shown in FIG. 3B.

In some embodiments, the functionality of the trigger node template 438 and the trigger node instance 440 may be realized due to the use of the trigger node-type template 444 and the trigger node-type instance 474, respectively. The trigger node-type template 444 has a description that is similar to the node-type template 344 of the node template 338 shown in FIG. 3B. Similarly, the predetermined trigger node-type template 464 may have a description that may be similar to the description of the predetermined node-type template 364. In other words, the edge node-type template 466 has a description similar to the description of edge node-type template 368 shown in FIG. 3B and the overlay node-type template 468 has a description similar to the description of the overlay node-type template 370 as shown in FIG. 3B.

The set of attribute templates 448 has a description that is similar to the description of the set of attribute templates 348 described in conjunction with FIG. 3B. The metadata 450 has a description that is similar to the metadata 350 depicted in FIG. 3B. Similarly, the set of attribute instances 476 has a description that is similar to the set of attribute instances 380 of FIG. 3B and the metadata 478 have a description that is similar to the metadata 382 of FIG. 3B.

The node configuration 452 has a description that may be similar to the node configuration 352 of FIG. 3B. In other words, the description of the node configuration strategies 460 may be similar to the description of the node configuration strategies 360, and the description of the node configuration extensions 462 is similar to the description of the node configuration extensions 362.

The unique ID 470 may have a description similar to the unique ID 374 described in conjunction with FIG. 3B. The version ID 472 may have a description similar to the version ID 376 described in conjunction with FIG. 3B. The trigger node-type instance 474 may have a description similar to the node-type instance 378. Similarly, the predetermined trigger node-type instance 480 may have a description that may be similar to the description of the predetermined node-type instances 384. In other words, the edge node-type instance 482 has a description similar to the description of edge node-type instance 388 shown in FIG. 3B and the overlay node-type instance 484 has a description similar to the description of the overlay node-type instance 390 as shown in FIG. 3B. The set of attribute instances 476 may have a description that may be similar to the description of the set of attribute instances 380 and the metadata 478 may have a description that may be similar to the description of the metadata 382.

Throughout the description, a node (for example, an active node, a trigger node, or the like) when associated with an overlay node is referred to as an executable node and may exhibit data as well as processing capability at run-time.

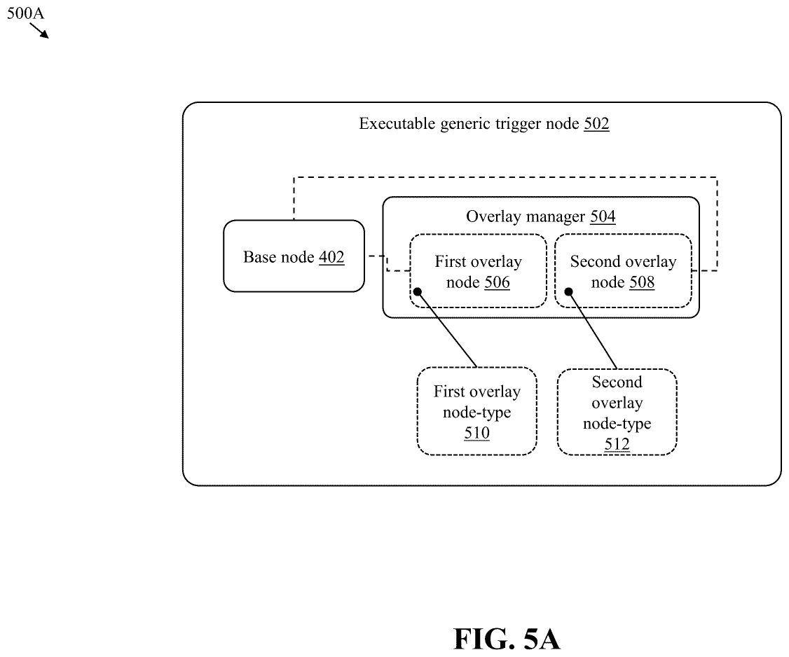

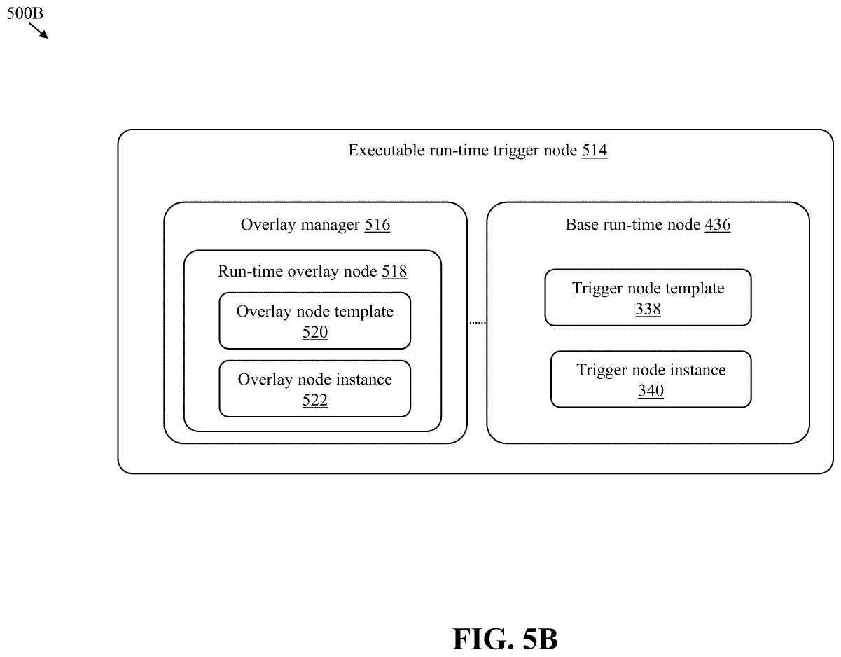

FIG. 5A is a block diagram 500A that illustrates an executable generic trigger node 502 within the executable graph-based model 100, consistent with disclosed embodiments of the present disclosure. Referring to FIG. 5A, the executable generic trigger node 502 is shown to include a base node (e.g., the generic trigger node 402) and an overlay manager 504. For the sake of ongoing discussion, the base node corresponds to the generic trigger node 402, and is hereinafter referred to as the “base node 402”. The base node 402 when extended by way of one or more overlay nodes becomes the executable generic trigger node 502. The executable generic trigger node 502 may have a first overlay node 506 and a second overlay node 508 associated therewith.

The overlay manager 504 registers and maintains one or more overlay nodes (such as the first and second overlay nodes 506 and 508) associated with the base node 402. The assignment of the first overlay node 506 and the second overlay node 508 to the base node 402 (via the overlay manager 504) endows the base node 402 with processing logic and executable functionality defined within the first and second overlay nodes 506 and 508.

The executable generic trigger node 502 provides processing functionality (e.g., processing logic) to the base node 402 via one or more associated overlay nodes (for example, the first overlay node 506 and the second overlay node 508). Beneficially, the data and processing capability of the base node 402 may be dynamically and significantly extended using the concept of an executable node (for example, the executable generic trigger node 502). As shown, the first overlay node 506 has a first overlay node-type 510 and the second overlay node 508 has a second overlay node-type 512. Therefore, the first overlay node 506 is associated with the first overlay node-type 510 and the second overlay node 508 is associated with the second overlay node-type 512. Examples of overlay node-types include, but are not limited to, a subscriber overlay node-type, a publisher overlay node-type, and an encryption overlay node-type.

A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic trigger node 502 is assumed to include the first and second overlay nodes 506 and 508, in other embodiments, the executable generic trigger node 502 may include any number of overlay nodes, without deviating from the scope of the present disclosure.

The executable generic trigger node 502 extends the base node 402 (or is a subtype of the base node 402) such that all the functionality and properties of the base node 402 are accessible to the executable generic trigger node 502. The executable generic trigger node 502 also dynamically extends the functionality of the base node 402 by associating the overlay nodes maintained by the overlay manager 504 with the base node 402. The executable generic trigger node 502 may thus be considered a combination of the base node 402 and the first and second overlay nodes 506 and 508. The executable generic trigger node 502 may be alternatively referred to as a node with overlay(s). Therefore, the executable generic trigger node 502 acts as a decorator of the base node 402 adding the functionality of the overlay manager 504 to the base node 402.

It will be apparent to a person skilled in the art that the base node 402 refers to any suitable node within the executable graph-based model 100. As such, the base node 402 may be a node having a node-type such as a vertex node-type, an edge node-type, an overlay node-type, a role node-type, or the like. Alternatively, the base node 402 may be an executable node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data (e.g., a vertex node as represented by the base node 402 in FIG. 5A) and the functionality that acts upon that data (e.g., an overlay node) can be separated and independently maintained offline, but at run-time, an association between the data node and the overlay node is determined and an executable node is generated (e.g., the executable generic trigger node 502 shown in FIG. 5A).

It will be apparent to a person skilled in the art that functionalities of the first and second overlay nodes 506 and 508 may be performed by a single overlay node that includes processing logic associated with both the first and second overlay nodes 506 and 508.

It will be apparent to a person skilled in the art that the list of overlay node-types is not exhaustive and the number of different overlay node-types that can be realized is not limited. Because an overlay node is itself a node, all functionality of a node described in relation to the base node 402 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 506 or the second overlay node 508, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays or cascading overlays. Also, a single overlay node may be associated with multiple executable nodes. Thus, the overlay node and functionality thereof may be shared among the multiple executable nodes.

The overlay manager 504 of the executable generic trigger node 502 is responsible for executing all overlays registered therewith. The overlay manager 504 also coordinates the execution of all associated overlay nodes. As shown in FIG. 5A, the executable generic trigger node 502 associates the base node 402 with two overlay nodes that is the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay.

Although FIG. 5A is described with respect to the generic trigger node 402 acting as the base node 402, various concepts and embodiments described herein may also be applicable to the generic node 302.

FIG. 5B is a block diagram 500B that illustrates an executable run-time trigger node 514 within the executable graph-based model 100, consistent with disclosed embodiments of the present disclosure. Referring to FIG. 5B, the executable run-time trigger node 514 is shown to include the run-time trigger node 436 (hereinafter referred to as ‘the base run-time node 436’) and an overlay manager 516. The base run-time node 436 may be associated with a run-time overlay node 518. Hence, the overlay manager 516 may include the run-time overlay node 518. The executable run-time trigger node 514 provides processing functionality (e.g., processing logic) to the base run-time node 436 via one or more associated overlay nodes (for example, the run-time overlay node 518). Beneficially, the data and processing capability of the base run-time node 436 may be dynamically and significantly extended using the concept of an executable run-time node (for example, the executable run-time trigger node 514).

Although the executable run-time trigger node 514 is shown to include a single run-time overlay node 518, in other embodiments, the executable run-time trigger node 514 may include any number of run-time overlay nodes. The run-time overlay node 518 may include an overlay node template 520 and an overlay node instance 522. The overlay node template 520 and an overlay node instance 522 may collectively constitute the run-time overlay node 518.

The executable run-time trigger node 514 extends the base run-time node 436 (or is a subtype of the base run-time node 436) such that all the functionalities and properties of the base run-time node 436 may be accessible to the executable run-time trigger node 514. The executable run-time trigger node 514 also dynamically extends the functionality of the base run-time node 436 by associating the run-time overlay nodes maintained by the overlay manager 516 with the base run-time node 436. The executable run-time trigger node 514 may thus be considered a composition of the base run-time node 436 and the run-time overlay node 518. The executable run-time trigger node 514 may be alternatively referred to as a run-time node with overlay(s). Therefore, the executable run-time trigger node 514 acts as a decorator of the base run-time node 436 adding the functionality of the overlay manager 516 to the base run-time node 436.

It will be apparent to a person skilled in the art that the base run-time node 436 refers to any suitable run-time node within the executable graph-based model 100. As such, the base run-time node 436 may be a run-time node having a node-type such as a vertex node-type, an edge node-type, or the like. Alternatively, the base run-time node 436 may itself be an executable node such that the functionality of the (executable) base run-time node 436 is dynamically extended. In this way, complex and powerful processing functionality can be dynamically generated by associating and extending overlay nodes.

The overlay manager 516 registers and maintains one or more run-time overlay nodes (such as the run-time overlay node 518) associated with the base run-time node 436. The assignment of the run-time overlay node 518 to the base run-time node 436 (via the overlay manager 516) endows the base run-time node 436 with processing logic and executable functionality defined within the run-time overlay node 518. In other words, the run-time overlay node 518 may interact at run-time, with the trigger node template 438 and/or the trigger node instance 440 of the base run-time node 436. In an example, the trigger node template 438 and the trigger node instance 440 may be not executable nodes. That is, neither the trigger node template 438 nor the trigger node instance 440 comprises an overlay manager with one or more run-time overlay nodes. In another example, the trigger node template 438 and/or the trigger node instance 440 may be executable nodes, thereby extending the functionality, complexity, and configurability of executable run-time nodes.

Extending the functionality of a base run-time node through one or more run-time overlay nodes is at the heart of the overlay system 202. As illustrated in FIG. 2, the data and the functionality that acts upon that data (e.g., an overlay node) can be separated and independently maintained offline, but at run-time, an association between the data node and the run-time overlay node is determined and an executable run-time node is generated (e.g., the executable run-time trigger node 514).

Each run-time overlay node comprises an overlay node template and an overlay node instance. The overlay node template is a node template with the overlay node-type template. Similarly, the overlay node instance is a node instance with the overlay node-type instance. The overlay node instance is an implementation of the overlay node template. The overlay node template comprises one or more generic rules that may be implemented by the processing logic of the overlay node instance. For example, a rule may be defined in an overlay node template specifying that hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

A run-time overlay node, such as the run-time overlay node 518, is a node having an overlay node-type (alternatively referred to as an overlay type) assigned to its node-type. Examples of overlay node-types include an encryption overlay node-type, an obfuscation overlay node-type, an audit overlay node-type, an analytics overlay node-type, a handler overlay node-type, a publisher overlay node-type, or the like. It will be apparent to a person skilled in the art that the list of overlay types is not exhaustive and the number of different overlay types that can be realized is not limited.

Because an overlay node is itself a node, all functionality of a node described in relation to the base run-time node 436 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

A run-time overlay node, such as the run-time overlay node 518, is not bound to a single executable node or a single executable graph-based model (unlike nodes that have non-overlay node-types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike non-run-time overlay nodes, a run-time overlay node may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time trigger node 514 is responsible for executing all overlays registered therewith. The overlay manager 516 also coordinates the execution of all associated overlay nodes. As shown in FIG. 5B, the executable run-time trigger node 514 associates the base run-time node 436 with the run-time overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

Although FIG. 5B is described with respect to the run-time trigger node 436 acting as the base run-time node 436, various concepts and embodiments described herein may also be applicable to the run-time node 336.

FIG. 6 is a block diagram 600 that illustrates a composition of the executable generic trigger node 502 that enables persistent storage of data and processing logic associated therewith, consistent with disclosed embodiments of the present disclosure.

As described in conjunction with FIG. 5A, the executable generic trigger node 502 includes the base node 402 and one or more overlay nodes (e.g., the first and second overlay nodes 506 and 508). For the sake of brevity of the ongoing description, the persistent storage is explained for the executable generic trigger node 502 including only the first overlay node 506. One or more operations performed for ensuring the persistence of the first overlay node 506 may be performed for the second overlay node 508 as well.

Referring to FIG. 6, the executable generic trigger node 502 includes the base node 402 and the first overlay node 506. The executable generic trigger node 502 has a corresponding first state 602 having a first ID 604. The base node 402 has a second state 606 having a second ID 608, and the first overlay node 506 has a third state 610 having a third ID 612. A manifest (for example, first through third manifests 614-618) is generated for each of the executable generic trigger node 502, the base node 402, and the first overlay node 506. In an embodiment, the manifests may be generated by the storage management module 220. The first manifest 614 is associated with the executable generic trigger node 502 and has a fourth ID 620 and an overlay ID 622. The second manifest 616 is associated with the base node 402 and has a fifth ID 624. The third manifest 618 is associated with the first overlay node 506 and has a sixth ID 626. Further, the manifests are stored at respective storage locations that may be centralized or distributed storage locations associated with the overlay system 202. The manifests may be stored by the storage management module 220.

The first state 602 of the executable generic trigger node 502 includes data required to reconstruct the executable generic trigger node 502 (e.g., attributes, properties, etc.). The first state 602 of the executable generic trigger node 502 is persistently stored along with the first ID 604. The first manifest 614 is generated for the executable generic trigger node 502 and has (i) the fourth ID 620 (which is the same as the first ID 604), (ii) the storage location of the first state 602 of the executable generic trigger node 502, and (iii) the overlay ID 622 (which is the same as the sixth ID 626). Notably, the fourth ID 620 is the same as the first ID 604 and the fifth ID 624, hence, the first manifest 614 includes the ID of the state of the base node 402 and the executable generic trigger node 502. Further, the overlay ID 622 is the same as the sixth ID 626 of the state of the first overlay node 506. Therefore, the first manifest 614 may be used to identify and retrieve the states of the base node 402, the executable generic trigger node 502, and the first overlay node 506. Subsequently, the retrieved states may be used to reconstruct the executable generic trigger node 502 and the first overlay node 506. In an instance, the executable generic trigger node 502 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the base node 402 includes data required to reconstruct the base node 402 (e.g., attributes, properties, etc.) and is persistently stored along with the second ID 608. The second manifest 616 is generated for the base node 402 and has the fifth ID 624 and the storage location of the second state 606 of the base node 402. The second ID 608 of the second state 606 and the fifth ID 624 of the second manifest 616 are the same as the first ID 604 of the first state 602 of the executable generic trigger node 502 (which is also the same as the fourth ID 620 of the first manifest 614 of the executable generic trigger node 502). As mentioned above, along with the first state 602, the first manifest 614 may also be used to identify and retrieve the second manifest 616 which in turn may be used to identify the second state 606 of the base node 402. A second manifest state (not shown) is then generated for the second manifest 616 and persistently stored along with the fifth ID 624. Thus, the states, manifests, and manifest states for the executable generic trigger node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 610 of the first overlay node 506 includes data required to reconstruct the first overlay node 506 (e.g., attributes, properties, processing logic, etc.) and is persistently stored along with the third ID 612. The third manifest 618 is generated for the first overlay node 506 and includes the sixth ID 626, which is the same as the third ID 612. Therefore, the first manifest 614 may be further used to identify and retrieve the third manifest 618 which in turn may be used to identify and retrieve the third state 610 of the first overlay node 506. A third manifest state (not shown) is then generated for the third manifest 618 and is persistently stored along with the sixth ID 626.

In operation, when the executable generic trigger node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 614 which includes the fourth ID 620 which is the same as the fifth ID 624 of the second manifest 616. Based on the fifth ID 624, the storage management module 220 may identify the second manifest state and may generate the second manifest 616 based on which the second state 606 is identified. Subsequently, the base node 402 is loaded and the storage management module 220 may determine that the base node is a node with overlay. Based on the fourth ID 620 (that is the same as the first ID 604 of the first state 602 of the executable generic trigger node 502) of the first manifest 614, the first state 602 is identified and retrieved. Subsequently, the executable generic trigger node 502 is loaded. Moreover, based on the overlay ID 622 (that is the same as the sixth ID 626 of the third manifest 618) of the first manifest 614, the third manifest state is identified and the third manifest 618 is generated. Subsequently, based on the sixth ID 626 (that is the same as the third ID of the third state) of the third manifest 618, the third state 610 is identified and retrieved. Based on the third state 610, the first overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 624. Based on the determined ID, the processing logic (such as the memory management module 218 and the storage management module 220) may identify the second manifest 616. Subsequently, the processing logic (such as the memory management module 218 and the storage management module 220) may identify the second state 606 that has the second ID 608 that matches the fifth ID 624. Further, the processing logic (such as the memory management module 218 and the storage management module 220) may retrieve the second state 606 associated with the second manifest 616 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic trigger node 502) with an ID that matches the second ID 608 and the fifth ID 624. Notably, the first manifest 614 includes storage locations of each overlay node (for example, the first overlay node 506) of the executable generic trigger node 502. Based on the overlay ID 622 included in the first manifest 614 that matches the sixth ID 626 included in the third manifest 618, the processing logic (such as the memory management module 218 and the storage management module 220) may identify and retrieve the third manifest 618 from a manifest storage of a plurality of manifest storages of the overlay system 202. Subsequently, the processing logic (such as the memory management module 218 and the storage management module 220) may identify the third state 610 which has the third ID 612 that matches the sixth ID 626. Further, the processing logic (such as the memory management module 218 and the storage management module 220) may retrieve the third state 610 associated with the third manifest 618 from a corresponding storage element. To determine whether the first overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 626. Since the first overlay node 506 does not have an overlay associated therewith, no other manifest has the ID that matches the sixth ID 626.

Notably, the manifest (the third manifest 618) of the first overlay node 506 includes a reference (such as an identifier that is common to the second manifest 616 and the third manifest 618, a link, a path, a storage location, or the like) to the second manifest 616 of the base node 402. Therefore, the re-formation of the executable generic trigger node 502 includes a re-creation of the first overlay node 506 prior to a re-creation of the base node 402. Subsequently, the first overlay node 506 and the base node 402 are organized by associating the base node 402 with the first overlay node 506 to re-form the executable generic trigger node 502.

In some embodiments, the first overlay node 506 may not be loaded in case it is not required for executing the operation associated with the stimulus 230. The loaded executable generic trigger node 502 and the first overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 6 illustrates only a single overlay node associated with a trigger node, in other embodiments, the executable generic trigger node 502 may include additional or different overlay nodes. It will also be apparent to a person skilled in the art that only those overlay nodes that are required for responding to the stimulus 230 may be loaded.

It will be apparent to a person skilled in the art that a generic node (for example, the generic node 302) may also be loaded in a manner similar to the loading of the base node 402. Similarly, an executable generic node may be loaded in a manner similar to the loading of the executable generic trigger node 502.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with overlay node template and overlay node instance, respectively, of the run-time overlay node. In such a scenario, each of the node template 338 and the node instance 340 may be loaded in a manner similar to the loading of the executable generic trigger node 502. Additionally, a run-time trigger node (for example, the run-time trigger node 426) may also be loaded in a manner similar to the loading of the run-time node 336.

Notably, a trigger node (for example, a generic trigger node and a run-time trigger node) may be loaded based on a requirement of an associated automation to be incorporated within the overlay system 202. The associated automation may be a capability of the trigger node to cause execution of a set of operations based on occurrence of an event. The requirement of the associated automation may act as a stimulus (for example, the stimulus 230) for loading the trigger node. In addition, an active node (for example, a generic node and a run-time node) may be loaded when any operation associated with the overlay system 202 may have to be executed based on the active node. In an instance, when a trigger node may be required to execute one or more operations using an active node, the active node may be loaded in the executable graph-based model 100 as described herein. In such an instance, determination of the set of operations to be executed based on the active node may act as a stimulus for loading the active node.

Having discussed various structural features and operational constraints associated with the overlay system 202, the description now moves towards implementation of the plurality of trigger nodes in conjunction with the plurality of active nodes while leveraging the structural features and the operational constraints of the overlay system 202.

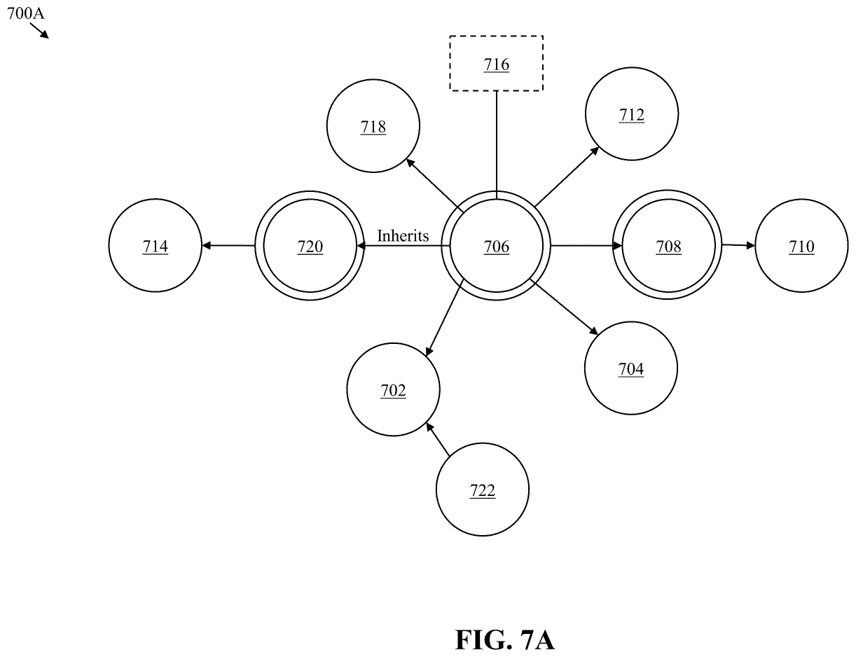

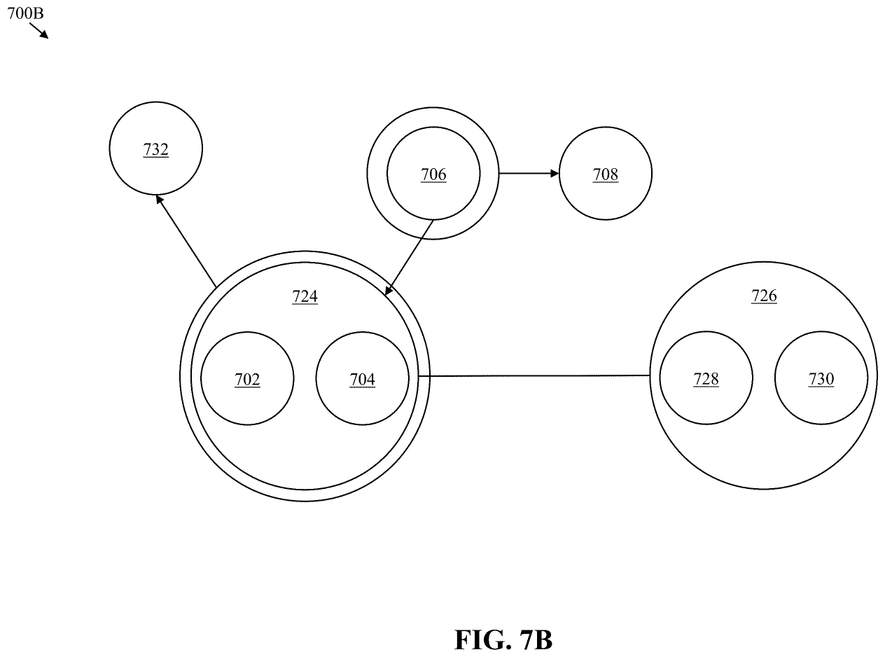

FIGS. 7A and 7B, collectively, illustrate graphs 700A and 700B that depict implementation of the plurality of trigger nodes in the executable graph-based model 100, consistent with disclosed embodiments of the present disclosure.

Referring to FIG. 7A, shown is the graph 700A that is an implementation of the executable graph-based model 100. The graph 700A is shown to include the plurality of active nodes and the plurality of trigger nodes. The plurality of active nodes are shown to include active nodes 702 and 704. Each active node of the plurality of active nodes may have a node state associated therewith. A change in a node state of an active node may be an event and may have to be followed with execution of a set of operations associated with the overlay system 202. Such an execution of the set of operations may be caused by a trigger node associated with the active node.

The plurality of trigger nodes shown in the graph 700A may include a trigger node 706. As shown, the trigger node 706 may be associated with the active node 702. The trigger node 706 may have a trigger node-type (for example, the trigger node-type 408) that is a combination of an edge node-type (for example, the edge node-type 330) and an overlay node-type (for example, the overlay node-type 332). The trigger node 706 may be associated with the active node 702 based on the edge node-type of the trigger node-type. Based on the trigger node-type including the overlay node-type, the trigger node 706 may further include processing logic that when executed may cause execution of one or more operations associated with the overlay system 202. The trigger node 706 may include a plurality of sets of criteria. One or more sets of criteria of the plurality of sets of criteria may pertain to the active node 702. Remaining sets of criteria of the plurality of sets of criteria may pertain to one or more other active nodes associated with the trigger node 706. Each set of criteria, when fulfilled (namely, met, complied with) by a set of conditions associated with the overlay system 202, may have to be followed by execution of a corresponding set of operations associated with the overlay system 202. Notably, the set of criteria may be fulfilled based on occurrence of an event that may have caused the set of conditions.

In operation, the processing circuitry (for example, the controller module 206, the transaction module 208, the trigger node management module 236, or the like) may be configured to identify the active node 702. In some embodiments, the active node 702 may be identified based on a requirement to automate a task associated with the active node 702. For example, the overlay system 202 may receive an input (for example, the stimulus 230) to automate execution of the task associated with the active node 702. The task may refer to one or more operations that may be executed based on the active node 702.

In an instance, based on the identification, the processing circuitry (for example, the controller module 206, the transaction module 208, the memory management module 218, the storage management module 220, or the like) may determine whether the active node 702 is unloaded from the executable graph-based model 100. Based on the active node 702 being unloaded from the executable graph-based model 100, the processing circuitry (for example, the controller module 206, the transaction module 208, the memory management module 218, the storage management module 220, or the like) may load the active node 702 as described in conjunction with FIG. 6.

Subsequently, to automate the execution, the processing circuitry (for example, the controller module 206, the transaction module 208, the trigger node management module 236, or the like) may be configured to determine the trigger node 706. In some embodiments, the processing circuitry (for example, the controller module 206, the transaction module 208, the trigger node management module 236, or the like) may determine the trigger node 706 based on the association thereof with the active node 702. In some embodiments, the processing circuitry (for example, the controller module 206, the transaction module 208, the trigger node management module 236, or the like) may determine the trigger node 706 based on the processing logic thereof being capable of causing the execution of the task for automation thereof. In some embodiments, the processing circuitry (for example, the controller module 206, the transaction module 208, the trigger node management module 236, or the like) may determine and subsequently associate the trigger node 706 with the active node 702.

The processing circuitry (for example, the controller module 206, the transaction module 208, the trigger node management module 236, or the like) may be further configured to use the trigger node 706 to detect a first event associated with the active node 702. In some embodiments, the first event may be detected based on a change of a node state of the active node 702. The processing circuitry (for example, the controller module 206, the transaction module 208, the trigger node management module 236, or the like) may use the trigger node 706 to detect the change in the node state of the active node 702. That is to say that, the processing circuitry (for example, the controller module 206, the transaction module 208, the trigger node management module 236, or the like) may use the trigger node 706 to continuously or periodically monitor the node state of the active node 702. Based on the monitoring, the change in the node state of the active node 702 may be detected as the first event.

In some embodiments, the processing circuitry (for example, the controller module 206, the transaction module 208, the trigger node management module 236, or the like) may detect the first event based on a first set of criteria of the plurality sets of criteria of the trigger node 706 being a match to a set of conditions associated with the overlay system 202. The first set of criteria may pertain to the active node 702 and the set of conditions may pertain to a current state of the executable graph-based model 100. Notably, the set of conditions of the overlay system 202 being the match to the first set of criteria of the plurality sets of criteria may indicate that the first set of criteria is being complied with, in association with the active node 702. Consequently, the first event may be detected. In an example, the first set of criteria associated with the trigger node 706 may include criteria ‘a change in node state’. The first set of criteria of the trigger node 706 may match the set of conditions being a changed node state of the active node 702. Therefore, the processing circuitry (for example, the controller module 206, the transaction module 208, the trigger node management module 236, or the like) may detect the change in the node state of the active node 702 as the first event.

The processing circuitry (for example, the controller module 206, the transaction module 208, the trigger node management module 236, or the like) may be further configured to determine a first set of operations to be executed in response to the first event. The first set of operations may be determined based on a fact that, when executed, the first set of operations may cause execution of the task that is to be automated. Notably, each set of criteria of the plurality of sets of criteria associated with the trigger node 706 may correspond to a set of operations. The first set of operations may correspond to the first set of criteria, that may have matched the set of conditions. Based on the first set of operations corresponding to the first set of criteria, the first set of operations is determined by the processing circuitry (for example, the controller module 206, the transaction module 208, the trigger node management module 236, or the like) to be executed in response to the first event. Referring to the ongoing example, the first set of criteria may correspond to a change in the node state of the active node 702. The first set of criteria may correspond to the first set of operations that when executed may perform a task of an audit operation for the active node 702. Therefore, the processing circuitry (for example, the controller module 206, the transaction module 208, the trigger node management module 236, or the like) may determine the first set of operations ‘execution of the audit operation’ to be executed in response to the first event.

The processing circuitry (for example, the controller module 206, the transaction module 208, the trigger node management module 236, or the like) may be further configured to execute the first set of operations in the overlay system 202. The first set of operations may be executed based on the active node 702 and the trigger node 706. In some embodiments, the first set of operations may be executed based on the processing logic of the trigger node 706. Referring back to the ongoing example, the first set of operations ‘execution of the audit operation’ may be executed based on execution of the processing logic of the trigger node 706 on the active node 702. The active node 702 may have a vertex node-type (for example, the vertex node-type 328), an edge node-type (for example, the edge node-type 330), or an overlay node-type (for example, the overlay node-type 332). The first set of operations may be executed based on data and/or processing logic that may be associated with the active node 702.

In some embodiments, the executable graph-based model 100 may further include a plurality of overlay nodes including overlay nodes 708, 710, 712, and 714. The plurality of overlay nodes depicted in FIG. 7A may be active nodes with an overlay node-type (for example, the overlay node-type 332). As shown, the overlay node 708 may be associated with the trigger node 706. In such an embodiment, the processing circuitry (for example, the controller module 206, the transaction module 208, or the like) may identify the overlay node 708 and the first set of operations may be executed further based on the overlay node 708. Referring back to the ongoing example, the overlay node 708 may be an auditing overlay node that may include processing logic that when executed may execute an auditing operation. Therefore, the first set of operations ‘execution of the audit operation’ may be executed further based on the overlay node 708.

In some embodiments, the trigger node 706 may further include an overlay manager 716. The overlay manager 716 may be configured to manage the association of the trigger node 706 with the overlay node 708. The overlay manager 716 may have a description that may be similar to the description of the overlay manager 504.

In some embodiments, the overlay node 708 may be further associated with the overlay node 710. The association of the trigger node 706 with the overlay node 708 and the association of the overlay node 708 with the overlay node 710 forms a series of cascading overlay nodes (namely, cascading overlay nodes). In such embodiments, the processing circuitry (for example, the controller module 206, the transaction module 208, or the like) may identify the overlay node 710 and the first set of operations may be executed further based on the overlay node 710. Referring back to the ongoing example, the overlay node 710 may include be a publisher overlay node. The processing circuitry (for example, the controller module 206, the transaction module 208, the trigger node management module 236, or the like) may further execute the first set of operations by publishing an audit report by way of the overlay node 710. The audit report may be an output of the execution of the audit operation.

In some embodiments, the overlay manager 716 may be configured to manage a sequence of applications of the overlay nodes 708 and 710. The sequence of applications may correspond to an order in which processing logic associated with the overlay nodes 708 and 710 may be executed. In an embodiment, the processing logic associated with the overlay node 710 may be executed prior to the execution of the processing logic associated with the overlay node 708. In another embodiment, the processing logic associated with the overlay node 708 may be executed prior to the execution of the processing logic associated with the overlay node 710.

In some embodiments, the trigger node 706 may be further associated with the overlay node 712. In such embodiments, the processing circuitry (for example, the controller module 206, the transaction module 208, or the like) may identify the overlay node 712 and the first set of operations may be executed further based on the overlay node 712. The overlay manager 716 may be further configured to manage the association of the trigger node 706 with the overlay node 712. The overlay manager 716 may be further configured to manage a sequence of operations of the overlay nodes 708, 710, and the overlay node 712. In an embodiment, the processing logic associated with the overlay node 712 may be executed prior to the execution of the processing logic associated with the overlay node 708. In another embodiment, the processing logic associated with the overlay node 708 may be executed prior to the execution of the processing logic associated with the overlay node 712. Referring to the ongoing example, the overlay node 712 may be a subscriber overlay node and may include processing logic that when executed may subscribe to information associated with the overlay system 202 that may be required for the execution of the audit operation.

In some embodiments, the trigger node 706 may be further associated with a trigger node 718. In such embodiments, the processing circuitry (for example, the controller module 206, the transaction module 208, or the like) may identify the trigger node 718 and the first set of operations may be executed further based on the trigger node 718. One or more operations associated with the trigger node 718 may be executed for the execution of the first set of operations. In an embodiment, an additional set of operations may be included in the first set of operations and the additional set of operations may be executed based on the execution of the first set of operations.

In some embodiments, the trigger node 706 may inherit a trigger node 720. In such embodiments, the processing circuitry (for example, the controller module 206, the transaction module 208, or the like) may identify the trigger node 720 and the first set of operations may be executed further based on the inherited trigger node 720. The inherited trigger node 720 may include processing logic that may be executed based on the execution of the processing logic associated with the trigger node 706. Referring to the ongoing example, the trigger node 720 may be configured to execute an operation for publishing the audit report based on the execution of the first set of operations for performing the audit of the active node 702 by the trigger node 706.

In some embodiments, the trigger node 720 may be associated with the overlay node 714. In such embodiments, the processing circuitry (for example, the controller module 206, the transaction module 208, or the like) may identify the overlay node 714 and the first set of operations may be executed further based on the overlay node 714. Referring to the ongoing example, the overlay node 714 may be an encryption overlay node. In an instance, an output of the first set of operations may include confidential data. The overlay node 714 may be used by the processing circuitry (for example, the controller module 206, or the like) to encrypt the output of the first set of operations in order to protect the data from unauthorized access.

In some embodiments, the active node 702 may be further associated with a trigger node 722. In such embodiments, the processing circuitry (for example, the controller module 206, the transaction module 208, or the like) may identify the trigger node 722 and the first set of operations may be executed further based on the trigger node 722. The trigger node 722 may be executed/triggered by the processing circuitry (for example, the controller module 206, or the like) based on the execution of the first set of operations. One or more operations associated with the trigger node 722 may be executed by the processing circuitry (for example, the controller module 206, or the like) for the execution of the first set of operations. Referring back to the ongoing example, the trigger node 722 may be configured to execute one or more operations to communicate the output of the first set of operations to an active node (for example, the active node 704) of the plurality of active nodes.

In some embodiments, as shown, the trigger node 706 is further associated with the active node 704. In such embodiments, the processing circuitry (for example, the controller module 206, the transaction module 208, or the like) may identify the active node 704 and the first set of operations may be executed further based on the active node 704. The first set of operations may be executed further based on the data and/or processing logic associated with the active node 704. Referring to the ongoing example, in addition to the audit of the active node 702, the first set of operations may be executed to audit the data and/or processing logic associated with the active node 704 as well. Therefore, the first set of operations may further include execution of the audit operation further based on the active node 704.

Referring to FIG. 7B, the graph 700B depicts another implementation of the executable graph-based model 100. The executable graph-based model 100 is further shown to include a plurality of group nodes. A group node may encompass two or more active nodes (for example, generic nodes or run-time nodes) of the plurality of active nodes. Each active node of the two or more active nodes may have a corresponding standard structure as described in conjunction with FIGS. 3A and 3B. In addition, each active node may be logically a part of the group node such that the group node may also have its corresponding node structure of an active node. Examples of a group node may include, but are not limited to, a sub-graph, a container, or the like. In some embodiments, the sub-graph and the container may also be implemented as a node of the executable graph-based model 100.

The plurality of group nodes may include group nodes 724 and 726. As shown, the group node 724 includes the active nodes 702 and 704 whereas the group node 726 includes active nodes 728 and 730. In some embodiments, the group node 724 may be associated with the trigger node 706. In such embodiments, the active nodes 702 and 704 may be associated with the trigger node 706 by way of the group node 724. In other words, the active nodes 702 and 704 may be associated with the trigger node 706 based on (i) the active nodes 702 and 704 being included in the group node 724 and (ii) the trigger node 706 being associated with the group node 724. Therefore, the first set of operations being executed based on the active node 702 and the trigger node 706 may be executed further based on the group node 724 as the active node 702 is associated with the trigger node 706 via the group node 724.

For the execution of the first set of operations, the processing circuitry (for example, the controller module 206, the transaction module 208, the trigger node management module 236, or the like) may be further configured to identify the group node 724 that includes the active node 702 and is associated with the trigger node 706. Subsequently, the first set of operations may be executed further based on the group node 724.

In some embodiments, the group node 724 may be further associated with an overlay node 732 of the plurality of overlay nodes of the executable graph-based model 100. In such embodiments, the processing circuitry (for example, the controller module 206, the transaction module 208, the trigger node management module 236, or the like) may be further configured to identify the overlay node 732. The first set of operations may be executed further based on the overlay node 732. In an example, the overlay node 732 may be a contract overlay node and may implement access control associated with the active nodes 702 and 704. In such an example, prior to the execution of the first set of operations, the processing circuitry (for example, the controller module 206, the transaction module 208, the trigger node management module 236, or the like) may be further configured to use the overlay node 732 to access the group node 724. In other words, prior to the execution of the first set of operations, the processing circuitry (for example, the controller module 206, the transaction module 208, the trigger node management module 236, or the like) may be further configured to use the overlay node 732 to access the active node 702 included in the group node 724 by way of the trigger node 706 associated with the group node 724.

For execution of the first set of operations, the processing circuitry (for example, the controller module 206, the transaction module 208, the overlay management module 238, or the like) may be further configured to identify the overlay node 732 associated with the group node 724. In an embodiment, the processing circuitry (for example, the controller module 206, the transaction module 208, the overlay management module 238, or the like) may determine that the group node 724 is associated with the overlay node 732. Processing logic associated with the overlay node 732 may be executed on the active nodes 702 and 704 by way of the group node 724. Thus, the processing circuitry (for example, the controller module 206, the transaction module 208, the trigger node management module 236, the overlay management module 238, or the like) may be further configured to execute the first set of operations further based on the overlay node 732.

In some embodiments, the group node 724 may be associated with the group node 726. In one instance, such an association between the group nodes 724 and 726 may be based on a parameter that may be common between the group nodes 724 and 726. In an example, the group node 724 may be associated with a parameter that may be a label ‘A’. The group node 726 may also be associated with the parameter that may be the label ‘A’. Therefore, based on the parameter that may be the label ‘A’ being common to each of the group nodes 724 and 726, the group node 724 and 726 may be coupled together. In another instance, such an association between the group nodes 724 and 726 may be based on an association between the active node 702 included in the group node 724 and the active node 728 included in the group node 726. Based on the association of the group nodes 724 and 726, the processing circuitry (for example, the controller module 206, the transaction module 208, the trigger node management module 236, or the like) may be further configured to identify the group node 726 and the first set of operations may be executed further based on the group node 726.

Notably, the nodes (for example, the active nodes 702 and 704, the overlay nodes 708-714, the group nodes 724-726, or the like) depicted in FIGS. 7A and 7B may be generic nodes or run-time nodes. Similarly, the trigger nodes (for example, the trigger nodes 706, 718, 720, and 722, or the like) depicted in FIGS. 7A and 7B may be generic trigger nodes or run-time trigger nodes. Based on the nodes being the generic nodes, the trigger nodes may be generic trigger nodes, whereas based on the nodes being the run-time nodes, the trigger nodes may be run-time trigger nodes.

In embodiments, when the nodes may be the run-time nodes, each node may include a node template and a node instance as depicted in FIG. 3B. Similarly, when the trigger nodes may be the run-time trigger nodes, each trigger node may include a trigger node template and a trigger node instance as depicted in FIG. 4B.

In some embodiments, when the active node 702 may be a run-time node, the overlay node 708 may be a run-time overlay node and may include a node template (namely, an overlay node template) and a node instance (namely, an overlay node instance) as described in conjunction with FIG. 3B.

In some embodiments, when the trigger node 706 may be a run-time trigger node, a trigger node template of the trigger node 706 may define the sequence of applications of (i) the overlay node 708 and 710, (ii) the overlay nodes 708, 710, and 712, or (iii) the overlay nodes 708 and 712.

Having described various features and concepts associated with the implementation of the trigger nodes in conjunction with the active nodes, the description now moves towards a use case scenario associated with the overlay system 202 described herein.

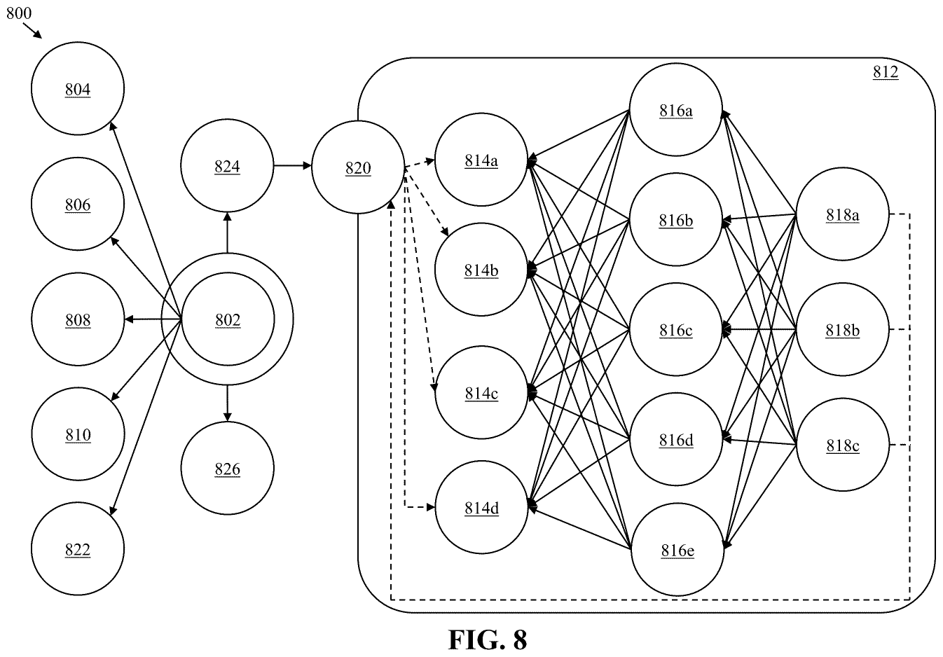

FIG. 8 illustrates a graph that depicts a user data management system 800 implemented based on the overlay system 202, consistent with disclosed embodiments of the present disclosure. Referring to FIG. 8, the graph is shown to include a person node 802 that may represent a first user of a plurality of users associated with the user data management system 800. The person node 802 may correspond to an active node with a vertex node-type (for example, the vertex node-type 328). The person node 802 may be associated with a gender node 804, an age node 806, a location node 808, and an income node 810 that may represent a gender, an age, a location, and an income, respectively of the first user represented by the person node 802.

The user data management system 800 may further include a group node 812. The group node 812 may include various active nodes that may form a neural network model (hereinafter depicted and referred to as the neural network model 812) that may be used to determine a political inclination of the users (for example, the first user) of the user data management system 100. The neural network model 812 may determine the political inclination of a user (for example, the first user) based on gender, age, location, and income of the user. The neural network model 812 is composed of a set of input nodes, a set of hidden nodes, and a set of output nodes. Each input node of the set of input nodes is coupled to each hidden node of the set of hidden nodes. Further, each hidden node of the set of hidden nodes is coupled to each output node of the set of output nodes. Each node of the neural network model 812 may correspond to an active node with an edge node-type (for example, the edge node-type 330).

The set of input nodes may include a gender input node 814a, an age input node 814b, a location input node 814c, and an income input node 814d. The gender input node 814a may receive a gender value (for example, male, female, or the like) associated with the user as a first portion of an input, the age input node 814b may receive an age value (for example, years, months, days) associated with the user as a second portion of the input, the location input node 814c may receive a geographical location (for example, state, city, or the like) associated with the user as a third portion of the input and, the income input node 814d may receive an income or income range (for example, a per day income, a per month income, an annual income, or the like) associated with the user as a fourth portion of the input. The first, second, third, and fourth portions, collectively, form the input. Further, the set of hidden nodes may include hidden nodes 816a-816e that may use the input received by the set of input nodes to determine the political inclination of the user. Further, the set of output nodes may include a first output node 818a, a second output node 818b, and a third output node 818c. The first output node 818a may represent a probability of the political inclination of the user being ‘Conservative’. The second output node 818b may represent a probability of the political inclination of the user being ‘Liberal’, and the third output node 818c may represent a probability of the political inclination of the user being ‘Moderate’.

The user data management system 800 is further shown to include a contract overlay node 820. The processing circuitry (for example, the controller module 206, the transaction module 208, or the like) may be configured to define and implement access control (for example, a public access, a private access, or a protected access) associated with the neural network model 812. The access control may be defined and implemented based on a set of access control constraints associated with the contract overlay node 820. The neural network model 812 may be accessed via the contract overlay node 820 and based on the set of access control constraints defined and implemented by the contract overlay node 820. Based on access to the neural network model 812 for providing the input to determine the political inclination of the user, an output indicative of the political inclination may be generated by the set of output nodes.

The user data management system 800 may further include a political inclination node associated with the node (for example, a political inclination node 822 associated with the person node 802) that represents a political inclination of the user. The output of the neural network model 812 may be a set of probabilities associated with the political inclination of the user being each of ‘Conservative’, ‘Liberal’, and ‘Moderate’. The political inclination node may correspond to an active node with the vertex node-type 328. The political inclination node may represent the political inclination of the user being one of ‘Conservative’, ‘Liberal’, and ‘Moderate’ with a highest corresponding probability of the set of probabilities.

Notably, based on a change in values of gender, age, location, or income, the political inclination of the user may change. Therefore, the political inclination may have to be updated in the user data management system 800. However, manual input of instructions (for example, an external stimulus) or an automatic generation of a stimulus (for example, an internal stimulus) may induce latency and complications in the user data management system 800. In order to mitigate such challenges, the user data management system 800 further includes trigger nodes (for example, a trigger node 824) associated with person nodes that represent the users of the system 800. The trigger nodes may include processing logic that may monitor the nodes representing gender, age, income, and location of users being represented by one or more associated person nodes. Based on a detection of a change in values of gender, age, income, or location associated with any associated person node, a corresponding trigger node may communicate with the neural network model 812. Such communication may be performed via the contract overlay node 820. Subsequently, the trigger nodes may receive an output of the neural network model 812 and may update a value of political inclination for the associated person node for which the change may have been detected.

In operation, the trigger node 824, based on an association thereof with the person node 802, may monitor the gender node 804, the age node 806, the location node 808, and the income node 810 to detect any changes. Based on detection of a change in values being represented by any of the gender node 804, the age node 806, the location node 808, and the income node 810, the trigger node 824 may detect a second event. Based on the detection of the second event, the trigger node 824 may communicate current values being represented by the gender node 804, the age node 806, the location node 808, and the income node 810 to the neural network model 812 as an input. The trigger node 824 may perform such communication via the contract overlay node 820. The input may be provided to the neural network model 812 via the set of input nodes including the gender input node 814a, the age input node 814b, the location input node 814c, and the income input node 814d. Notably, in case a first data organization schema associated with the neural network model 812 may be different from a second data organization schema associated with the person node 802, the trigger node 824 may be further configured to perform a mapping between the first and second data organization schema. Based on the mapping, the values being represented by the gender node 804, the age node 806, the location node 808, and the income node 810 may be transformed to conform with the first data organization schema before being provided to the neural network model 812 as the input.

The neural network model 812 may process the input using the set of hidden nodes to determine probabilities associated with a current political inclination of the first user being represented by the person node 802. The neural network model 812 may determine a first set of probabilities for the political inclination of the first user being ‘Conservative’, ‘Liberal’, and ‘Moderate’ and generate the first set of probabilities as an output at the set of output nodes. The trigger node 824 may receive the output from the set of output nodes via the contract overlay node 820. Based on the set of probabilities, the trigger node 824 may derive a political inclination of the first user and may store the derived political inclination of the first user at the political inclination node 822.

Although the implementation of the trigger node is discussed for user data management, such an implementation should not be constituted as a limitation of the disclosure. The overlay system 202 that facilitates the trigger nodes may have applications in various other domains including, but not limited to, management of graph-based models, automation of operations in the graph-based models, and monitoring of graph-based models.

Various operations that may be performed by way of the trigger nodes may include, but are not limited to, event handling, initiation of relevant graph algorithms based on an event, data storage, graph visualization, node addition, node removal, node composition updates, graph property changes, sub-graph identification, monitoring of graph thresholds and execution of corresponding response operations, maintaining back-ups, graph partitioning, and monitoring of temporal changes and execution of one or more relevant operations based on occurrence of a temporal change.

It will be appreciated by a person skilled in the art that any operation being performed by a node (for example, an active node, an overlay node, a trigger node, or the like) may be performed by the processing circuitry (for example, the controller module 206, the transaction module 208, the trigger node management module 236, the overlay management module 238, or the like) using the node.

Having discussed various concepts, operations, and usage associated with the overlay system 202 facilitating the trigger nodes, the description now moves towards a computing system for implementing the overlay system 202 that incorporates trigger nodes.

FIG. 9 shows an example computing system 900 for carrying out methods of the present disclosure, consistent with disclosed embodiments of the present disclosure. Specifically, FIG. 9 shows a block diagram of an embodiment of the computing system 900 according to example embodiments of the present disclosure.

The computing system 900 may be configured to perform any of the operations disclosed herein, such as any of the operations discussed with reference to the functional modules described in relation to FIG. 2. The computing system 900 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 900 is a distributed system configured to function using multiple computing machines interconnected via a data network or bus system.

The computing system 900 includes computing devices (such as a computing device 902). The computing device 902 includes one or more processors (such as a processor 904) and a memory 906. The processor 904 may be any general-purpose processor(s) configured to execute a set of instructions. For example, the processor 904 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 904 may be multiple processing units, a single processing core, multiple processing cores, special purpose processing cores, co-processors, or any combination thereof. The processor 904 may be communicatively coupled to the memory 906 via an address bus 908, a control bus 910, a data bus 912, and a messaging bus 914.

The memory 906 may include non-volatile memories such as a read-only memory (ROM), a programable read-only memory (PROM), an erasable programmable read-only memory (EPROM), a flash memory, or any other device capable of storing program instructions or data with or without applied power. The memory 906 may also include volatile memories, such as a random-access memory (RAM), a static random-access memory (SRAM), a dynamic random-access memory (DRAM), and a synchronous dynamic random-access memory (SDRAM). The memory 906 may include single or multiple memory modules. While the memory 906 is depicted as part of the computing device 902, a person skilled in the art will recognize that the memory 906 can be separate from the computing device 902.

The memory 906 may store information that can be accessed by the processor 904. For instance, the memory 906 (e.g., one or more non-transitory computer-readable storage mediums, memory devices) may include computer-readable instructions (not shown) that can be executed by the processor 904. The computer-readable instructions may be software written in any suitable programming language or may be implemented in hardware. Additionally, or alternatively, the computer-readable instructions may be executed in logically and/or virtually separate threads on the processor 904. For example, the memory 906 may store instructions (not shown) that when executed by the processor 904 cause the processor 904 to perform operations such as any of the operations and functions for which the computing system 900 is configured, as described herein. Additionally, or alternatively, the memory 906 may store data (not shown) that can be obtained, received, accessed, written, manipulated, created, and/or stored. The data can include, for instance, the data and/or information described herein in relation to FIGS. 1-8. In some implementations, the computing device 902 may obtain from and/or store data in one or more memory device(s) that are remote from the computing system 900.

The computing device 902 may further include an input/output (I/O) interface 916 communicatively coupled to the address bus 908, the control bus 910, and the data bus 912. The data bus 912 and messaging bus 914 may include a plurality of tunnels that may support parallel execution of messages by the overlay system 202. The I/O interface 916 is configured to couple to one or more external devices (e.g., to receive and send data from/to one or more external devices). Such external devices, along with the various internal devices, may also be known as peripheral devices. The I/O interface 916 may include both electrical and physical connections for operably coupling the various peripheral devices to the computing device 902. The I/O interface 916 may be configured to communicate data, addresses, and control signals between the peripheral devices and the computing device 902. The I/O interface 916 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 916 is configured to implement only one interface or bus technology. Alternatively, the I/O interface 916 is configured to implement multiple interfaces or bus technologies. The I/O interface 916 may include one or more buffers for buffering transmissions between one or more external devices, internal devices, the computing device 902, or the processor 904. The I/O interface 916 may couple the computing device 902 to various input devices, including mice, touch screens, scanners, biometric readers, electronic digitizers, sensors, receivers, touchpads, trackballs, cameras, microphones, keyboards, any other pointing devices, or any combinations thereof. The I/O interface 916 may couple the computing device 902 to various output devices, including video displays, speakers, printers, projectors, tactile feedback devices, automation control, robotic components, actuators, motors, fans, solenoids, valves, pumps, transmitters, signal emitters, lights, and so forth.

The computing system 900 may further include a storage unit 918, a network interface 920, an input controller 922, and an output controller 924. The storage unit 918, the network interface 920, the input controller 922, and the output controller 924 are communicatively coupled to the central control unit (e.g., the memory 906, the address bus 908, the control bus 910, and the data bus 912) via the I/O interface 916. The network interface 920 communicatively couples the computing system 900 to one or more networks such as wide area networks (WAN), local area networks (LAN), intranets, the Internet, wireless access networks, wired networks, mobile networks, telephone networks, optical networks, or combinations thereof. The network interface 920 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 918 is a computer-readable medium, preferably a non-transitory computer-readable medium, comprising one or more programs, the one or more programs comprising instructions which when executed by the processor 904 cause the computing system 900 to perform the method steps of the present disclosure. Alternatively, the storage unit 918 is a transitory computer-readable medium. The storage unit 918 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 918 stores one or more operating systems, application programs, program modules, data, or any other information. The storage unit 918 is part of the computing device 902. Alternatively, the storage unit 918 is part of one or more other computing machines that are in communication with the computing device 902, such as servers, database servers, cloud storage, network attached storage, and so forth.

The input controller 922 may include suitable logic, circuitry, interfaces, and/or code, executable by the circuitry, that may be configured to control one or more input devices that may be configured to receive an input for the overlay system 202. The output controller 924 may include suitable logic, circuitry, interfaces, and/or code, executable by the circuitry, that may be configured to control one or more output devices that may be configured to render/output the outcome (e.g., the outcome 234) of the operation executed to process the received input.

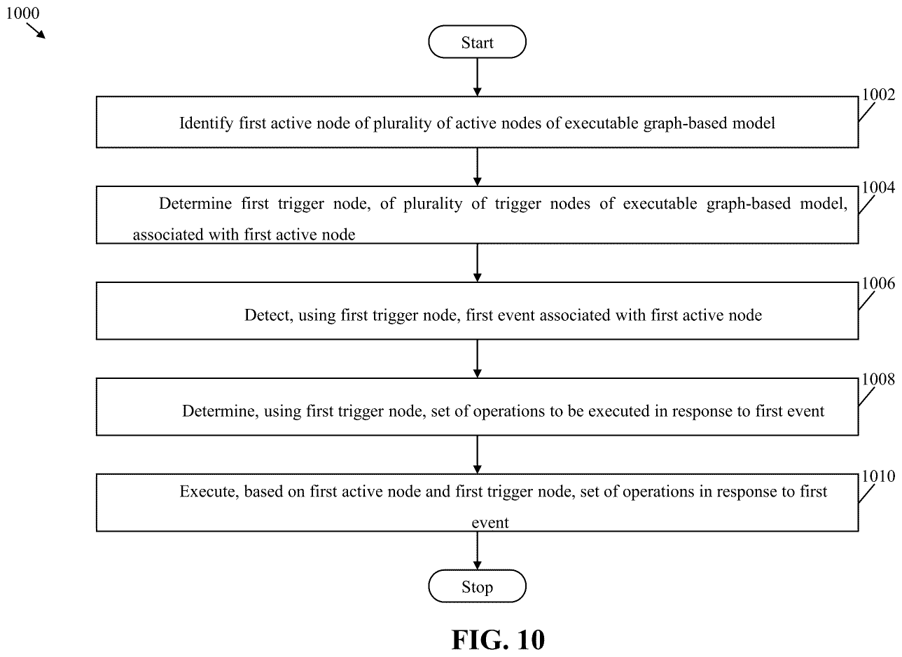

FIG. 10 illustrates a flowchart 1000 of a method for implementation of a trigger node in the executable graph-based model 100, consistent with disclosed embodiments of the present disclosure. Referring to FIG. 10, at 1002, a first active node of a plurality of active nodes of the executable graph-based model 100 may be identified. The processing circuitry (for example, the controller module 206 and the transaction module 208) may be configured to identify the first active node (for example, the active node 702) of overlay system 202.

At 1004, a first trigger node (for example, the trigger node 706) of a plurality of trigger nodes of the executable graph-based model 100, associated with first active node may be determined. The processing circuitry (for example, the controller module 206, the context module 210, and the stimuli management module 212) may be configured to determine the first trigger node from the plurality of trigger nodes.

At 1006, a first event, using the first trigger node, associated with the first active node may be detected. The processing circuitry (for example, the controller module 206, the context module 210, and the trigger node management module 236) may be configured to detect the first event. The processing circuitry (for example, the controller module 206, the context module 210, and the trigger node management module 236) may be configured to perform such detection by using the first trigger node associated with the first active node. The first event node may be detected based on compliance of a set of criteria associated with the first trigger node. The set of criteria may be complied with in association with the first active node.

At 1008, a set of operations, to be executed in response to the first event, may be determined. The processing circuitry (for example, the controller module 206, the context module 210, and the trigger node management module 236) may determine the set of operations to be executed in response to the first event. The processing circuitry (for example, the controller module 206, the context module 210, and the trigger node management module 236) may use the first trigger node for such a determination of the set operations.

At 1010, the set of operations may be executed in response to the first event. The processing circuitry (for example, the controller module 206, the transaction module 208, or the like) may execute the set of operations in response to the first event. The set of operations may be executed based on the first active node and the first trigger node.

The disclosed embodiments encompass numerous advantages including a simple and user-friendly implementation of the executable graph-based model 100 that may be in turn used to implement various complex and advanced applications. The overlay system 202 facilitates the implementation of trigger nodes in the executable graph-based model 100 that incorporates automation within the overlay system 202. The implementation of the trigger nodes significantly eliminates dependency on stimuli for execution of operations associated with the overlay system 202. Hence, the disclosed overlay system 202 exhibits significant enhancement in efficiency and responsiveness of graph-based models. By enabling proactive execution of processing logic within overlay nodes, the overlay system 202 enables execution of operations in a continuous or scheduled manner without having to wait for the stimulus. This reduces delays associated with stimulus invocation, leading to improved system throughput and reduced latency of the overlay system 202. As a result, an overall performance of the overlay system 202 is optimized, making it better suited for applications requiring high-speed processing, such as real-time analytics, financial modeling, and dynamic recommendation engines.

Additionally, the removal of stimulus dependency enhances the scalability and adaptability of the system, particularly in unpredictable environments where external inputs may be inconsistent. By enabling trigger nodes to cause automatic execution of operations based on predefined conditions or constraints, the overlay system 202 exhibits significantly consistent and reliable performance. The implementation of trigger nodes also facilitates better resource utilization by preventing idle processing time, ultimately leading to a more robust and efficient architecture for complex data processing and analysis. Application areas of the systems and methods disclosed herein may encompass various domains that may require automated actions on specific events such as fraud detection, smart home systems, gaming platforms, social media platforms, research and analytics platforms, robotics, or the like.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for facilitating implementation of trigger nodes in executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
   a storage element configured to store an executable graph-based model that includes a plurality of active nodes and a plurality of trigger nodes, with each trigger node being associated with at least one active node of the plurality of active nodes; and
   processing circuitry that is coupled to the storage element, and configured to:
   identify a first active node of the plurality of active nodes;
   determine a first trigger node, of the plurality of trigger nodes, associated with the first active node;
   detect, using the first trigger node, a first event associated with the first active node;
   determine, using the first trigger node, a set of operations to be executed in response to the first event; and
   execute, based on the first active node and the first trigger node, the set of operations in response to the first event.
2. The overlay system of 1, wherein the first event is detected based on a set of criteria associated with the first trigger node.
3. The overlay system of 2, wherein the first event is detected further based on the set of criteria being complied with in association with the first active node.
4. The overlay system of 1,
   wherein the executable graph-based model further includes a plurality of overlay nodes,
   wherein the processing circuitry is further configured to determine one or more overlay nodes, of the plurality of overlay nodes, associated with the first trigger node, and
   wherein the set of operations is executed further based on the one or more overlay nodes associated with the first trigger node.
5. The overlay system of 4, wherein the first trigger node includes an overlay manager configured to manage the association of the first trigger node with the one or more overlay nodes.
6. The overlay system of 1,
   wherein the executable graph-based model further includes a plurality of overlay nodes,
   wherein the processing circuitry is further configured to determine at least two overlay nodes, of the plurality of overlay nodes, associated with the first trigger node,
   wherein the at least two overlay nodes are associated with the first trigger node in a series of cascading overlay nodes, and
   wherein the set of operations is executed further based on the at least two overlay nodes associated with the first trigger node.
7. The overlay system of 6, wherein the first trigger node includes an overlay manager configured to manage at least one of a group consisting of (i) the association of the first trigger node with the at least two overlay nodes, or (ii) a sequence of applications of the at least two overlay nodes for the execution of the set of operations.
8. The overlay system of 1,
   wherein the processing circuitry is further configured to determine a second trigger node, of the plurality of trigger nodes, associated with the first trigger node, and
   wherein the set of operations is executed further based on the second trigger node.
9. The overlay system of 1,
   wherein the processing circuitry is further configured to determine a third trigger node, of the plurality of trigger nodes, associated with the first active node, and
   wherein the set of operations is executed further based on the third trigger node.
10. The overlay system of 1,
   wherein the processing circuitry is further configured to determine at least a fourth trigger node, of the plurality of trigger nodes, inherited by the first trigger node, and
   wherein the set of operations is executed further based on at least the fourth trigger node.
11. The overlay system of 10,
   wherein the executable graph-based model further includes a plurality of overlay nodes,
   wherein the processing circuitry is further configured to determine one or more overlay nodes, of the plurality of overlay nodes, associated with the fourth trigger node, and
   wherein the set of operations is executed further based on the one or more overlay nodes associated with the fourth trigger node inherited by the first trigger node.
12. The overlay system of 1,
   wherein the processing circuitry is further configured to determine a second active node, of the plurality of active nodes, associated with the first trigger node, and
   wherein the set of operations is executed further based on the second active node.
13. The overlay system of 1,
   wherein the executable graph-based model further includes a plurality of group nodes with each group node including two or more active nodes of the plurality of active nodes,
   wherein the processing circuitry is further configured to identify a first group node, of the plurality of group nodes, which includes the first active node,
   wherein the first active node is associated with the first trigger node by way of the first group node, and
   wherein the set of operations is executed further based on the first group node.
14. The overlay system of 13,
   wherein the executable graph-based model further includes a plurality of overlay nodes,
   wherein the processing circuitry is further configured to determine one or more overlay nodes, of the plurality of overlay nodes, associated with the first group node, and
   wherein the set of operations is executed further based on the one or more overlay nodes associated with the first group node.
15. The overlay system of 13,
   wherein the processing circuitry is further configured to determine a second group node, of the plurality of group nodes, associated with the first group node, and
   wherein the set of operations is executed further based on the second group node.
16. The overlay system of 1, wherein the first active node is a generic node, and wherein the first trigger node is a generic trigger node.
17. The overlay system of 1,
   wherein the first active node is a run-time node including (i) a node template that is a predefined node structure and (ii) a node instance that is an implementation of the node template, and
   wherein the first trigger node is a run-time trigger node having (i) a trigger node template that is a predefined trigger node structure and (ii) a trigger node instance that is an implementation of the trigger node template.
18. The overlay system of 17,
   wherein the executable graph-based model further includes a plurality of overlay nodes,
   wherein the processing circuitry is further configured to determine two or more overlay nodes, of the plurality of overlay nodes, associated with the first trigger node,
   wherein the set of operations is executed further based on the two or more overlay nodes, and
   wherein the trigger node template of the first trigger node defines a sequence of applications of the two or more overlay nodes for the execution of the set of operations.
19. The overlay system of 18, wherein based on the first trigger node being the run-time trigger node, each of the two or more overlay nodes is a run-time overlay node having (i) an overlay node template that is a predefined overlay node structure and (ii) an overlay node instance that is an implementation of the overlay node template.
20.The overlay system of 1, wherein an active node of the plurality of active nodes is one of a group consisting of: an edge node, a vertex node, a role node, or an overlay node.
21.The overlay system of 1,
   wherein a trigger node of the plurality of trigger nodes has a trigger node-type, and
   wherein the trigger node-type is a combination of an edge node-type and an overlay node-type.
22. A method comprising:
   identifying, by processing circuitry, a first active node of a plurality of active nodes of an executable graph-based model;
   determining, by the processing circuitry, a first trigger node, of a plurality of trigger nodes of the executable graph-based model, associated with the first active node,
      wherein the executable graph-based model is stored in a storage element of an overlay system, and
      wherein each trigger node of the plurality of trigger nodes is associated with at least one active node of the plurality of active nodes;
   detecting, by the processing circuitry using the first trigger node, a first event associated with the first active node;
   determining, by the processing circuitry using the first trigger node, a set of operations to be executed in response to the first event; and
   executing, by the processing circuitry, based on the first active node and the first trigger node, the set of operations in response to the first event.

What is claimed is:

1. An overlay system, comprising:
a storage element configured to store an executable graph-based model that includes a plurality of active nodes and a plurality of trigger nodes, with each trigger node being associated with at least one active node of the plurality of active nodes; and
processing circuitry that is coupled to the storage element, and configured to:
identify a first active node of the plurality of active nodes;
determine a first trigger node, of the plurality of trigger nodes, associated with the first active node;
detect, using the first trigger node, a first event associated with the first active node;
determine, using the first trigger node, a set of operations to be executed in response to the first event; and
execute, based on the first active node and the first trigger node, the set of operations in response to the first event.

2. The overlay system of claim 1, wherein the first event is detected based on a set of criteria associated with the first trigger node.

3. The overlay system of claim 2, wherein the first event is detected further based on the set of criteria being complied with in association with the first active node.

4. The overlay system of claim 1,
wherein the executable graph-based model further includes a plurality of overlay nodes,
wherein the processing circuitry is further configured to determine one or more overlay nodes, of the plurality of overlay nodes, associated with the first trigger node, and
wherein the set of operations is executed further based on the one or more overlay nodes associated with the first trigger node.

5. The overlay system of claim 4, wherein the first trigger node includes an overlay manager configured to manage the association of the first trigger node with the one or more overlay nodes.

6. The overlay system of claim 1,
wherein the executable graph-based model further includes a plurality of overlay nodes,
wherein the processing circuitry is further configured to determine at least two overlay nodes, of the plurality of overlay nodes, associated with the first trigger node,
wherein the at least two overlay nodes are associated with the first trigger node in a series of cascading overlay nodes, and
wherein the set of operations is executed further based on the at least two overlay nodes associated with the first trigger node.

7. The overlay system of claim 6, wherein the first trigger node includes an overlay manager configured to manage at least one of a group consisting of (i) the association of the first trigger node with the at least two overlay nodes, or (ii) a sequence of applications of the at least two overlay nodes for the execution of the set of operations.

8. The overlay system of claim 1,
wherein the processing circuitry is further configured to determine a second trigger node, of the plurality of trigger nodes, associated with the first trigger node, and
wherein the set of operations is executed further based on the second trigger node.

9. The overlay system of claim 1,
wherein the processing circuitry is further configured to determine a third trigger node, of the plurality of trigger nodes, associated with the first active node, and
wherein the set of operations is executed further based on the third trigger node.

10. The overlay system of claim 1,
wherein the processing circuitry is further configured to determine at least a fourth trigger node, of the plurality of trigger nodes, inherited by the first trigger node, and
wherein the set of operations is executed further based on at least the fourth trigger node.

11. The overlay system of claim 10,
wherein the executable graph-based model further includes a plurality of overlay nodes,
wherein the processing circuitry is further configured to determine one or more overlay nodes, of the plurality of overlay nodes, associated with the fourth trigger node, and
wherein the set of operations is executed further based on the one or more overlay nodes associated with the fourth trigger node inherited by the first trigger node.

12. The overlay system of claim 1,
wherein the processing circuitry is further configured to determine a second active node, of the plurality of active nodes, associated with the first trigger node, and
wherein the set of operations is executed further based on the second active node.

13. The overlay system of claim 1,
wherein the executable graph-based model further includes a plurality of group nodes with each group node including two or more active nodes of the plurality of active nodes,
wherein the processing circuitry is further configured to identify a first group node, of the plurality of group nodes, which includes the first active node,
wherein the first active node is associated with the first trigger node by way of the first group node, and
wherein the set of operations is executed further based on the first group node.

14. The overlay system of claim 13,
wherein the executable graph-based model further includes a plurality of overlay nodes,
wherein the processing circuitry is further configured to determine one or more overlay nodes, of the plurality of overlay nodes, associated with the first group node, and
wherein the set of operations is executed further based on the one or more overlay nodes associated with the first group node.

15. The overlay system of claim 13,
wherein the processing circuitry is further configured to determine a second group node, of the plurality of group nodes, associated with the first group node, and
wherein the set of operations is executed further based on the second group node.

16. The overlay system of claim 1, wherein the first active node is a generic node, and wherein the first trigger node is a generic trigger node.

17. The overlay system of claim 1,
wherein the first active node is a run-time node including (i) a node template that is a predefined node structure and (ii) a node instance that is an implementation of the node template, and
wherein the first trigger node is a run-time trigger node having (i) a trigger node template that is a predefined trigger node structure and (ii) a trigger node instance that is an implementation of the trigger node template.

18. The overlay system of claim 17,
wherein the executable graph-based model further includes a plurality of overlay nodes,
wherein the processing circuitry is further configured to determine two or more overlay nodes, of the plurality of overlay nodes, associated with the first trigger node,
wherein the set of operations is executed further based on the two or more overlay nodes, and
wherein the trigger node template of the first trigger node defines a sequence of applications of the two or more overlay nodes for the execution of the set of operations.

19. The overlay system of claim 18, wherein based on the first trigger node being the run-time trigger node, each of the two or more overlay nodes is a run-time overlay node having (i) an overlay node template that is a predefined overlay node structure and (ii) an overlay node instance that is an implementation of the overlay node template.

20. A method comprising:
identifying, by processing circuitry, a first active node of a plurality of active nodes of an executable graph-based model;
determining, by the processing circuitry, a first trigger node, of a plurality of trigger nodes of the executable graph-based model, associated with the first active node,
wherein the executable graph-based model is stored in a storage element of an overlay system, and
wherein each trigger node of the plurality of trigger nodes is associated with at least one active node of the plurality of active nodes;
detecting, by the processing circuitry using the first trigger node, a first event associated with the first active node;
determining, by the processing circuitry using the first trigger node, a set of operations to be executed in response to the first event; and
executing, by the processing circuitry, based on the first active node and the first trigger node, the set of operations in response to the first event.
